(19) United States
(12) Patent Application Publication
(10) Pub. No.: US 2025/0207676 A1
(43) Pub. Date: Jun. 26, 2025

(54) MAGNETIC VALVE TRIM FOR RELIEF VALVES

(71) Applicant: Fisher Jeon Gas Equipment (Chengdu) Co., LTD., Chengdu (CN)

(72) Inventors: Guolei Fan, Chengdu (CN); Runtong Zhou, Chengdu (CN)

(21) Appl. No.: 18/981,105

(22) Filed: Dec. 13, 2024

(30) Foreign Application Priority Data
Dec. 25, 2023 (CN) 202323560851.5

(51) Int. Cl. F16K 17/02

(52) U.S. Cl. CPC F16K 17/02

(57) ABSTRACT

Magnetic valve trim assemblies for relief valves are disclosed. An example relief valve includes a valve body defining a fluid flow path between a first port and a second port. A valve seat is interposed in the fluid flow path. A pallet is movable relative to the valve seat from a closed position and an open position in response to a pressure differential across the pallet exceeding a set point of the relief valve. A valve stem is coupled to the pallet. A magnet assembly provides a magnetic attraction force to at least one of: (1) at least partially assist in moving the pallet away from the valve seat when the pallet is moving from the closed position to the open position; or (2) at least partially assist in moving the pallet toward the valve seat when the pallet moves from the open position to the closed position.

### FIELD OF THE DISCLOSURE

This disclosure relates generally to relief valves and, more particularly, to magnetic valve trim for relief valves.

### BACKGROUND

Fluid distribution systems (e.g., petroleum refining, petrochemical, chemical manufacturing, natural gas processing, and power generation) can include relief valves such as pressure and/or vacuum relief valves to protect system components against damage.

### SUMMARY

An example relief valve includes a valve body defining a fluid flow path between a first port and a second port. A valve seat is interposed in the fluid flow path. A pallet is movable relative to the valve seat from a closed position and an open position in response to a pressure differential across the pallet exceeding a set point of the relief valve. A valve stem is coupled to the pallet. A magnet assembly provides a magnetic attraction force to at least partially assist moving the pallet in a direction toward the valve seat when the pallet moves from the open position to the closed position.

An example relief valve includes a valve body defining a fluid flow path between a first port and a second port. A valve seat is interposed in the fluid flow path. A pallet is movable relative to the valve seat from a closed position and an open position in response to a pressure differential across the pallet exceeding a set point of the relief valve. A valve stem is coupled to the pallet. A magnet assembly provides a magnetic attraction force to at least partially assist in moving the pallet away from the valve seat when the pallet is moving from the closed position to the open position.

Another example relief valve includes a fluid body defining a fluid flow path between an inlet port and an outlet port, a valve seat interposed in the fluid flow path, and a pallet movable relative to the valve seat. The pallet has a first side oriented toward the valve seat and a second side opposite the first side. A valve stem has a first end coupled to the second side of the pallet and a second end extending therefrom. A magnet holder is suspended adjacent the second end of the valve stem. A magnet assembly provides a pressure set point of the relief valve. The magnet assembly includes a first magnet and a second magnet. The first magnet is coupled to the second end of the valve stem and the second magnet is coupled to the magnet holder.

Another example relief valve includes a valve body defining a fluid flow path between a first port and a second port and a trim assembly to control fluid flow through the fluid flow path. The trim assembly includes a valve seat positioned in the fluid flow path between the first port and the second port, a pallet moveable relative to the valve seat, a valve stem having a first end coupled to the pallet and a second end protruding away from the pallet, a first magnet coupled to the second end of the valve stem. A magnet holder is positioned adjacent the second end of the valve stem and a second magnet is coupled to the magnet holder. The first magnet and the second magnet positioned outside of the first flow path.

### BRIEF DESCRIPTION OF THE DRAWINGS

FIG. 1A is a perspective view of an example relief valve in accordance with teachings of this disclosure.

FIG. 1B is a perspective, cross-sectional view of the example relief valve of FIG. 1A.

FIG. 2A is a perspective view of an example first valve trim assembly of FIGS. 1A and 1B.

FIG. 2B is an exploded view of the example first valve trim assembly 118 of FIG. 2A.

FIG. 3A is a perspective view of an example first flow control member of FIGS. 2A and 2B.

FIG. 3B is a perspective, partial exploded view of the example first flow control member of FIG. 3B.

FIG. 4A is a perspective view of an example first valve seat of FIGS. 2A and 2B shown without an example second magnet.

FIG. 4B is a perspective view of the example first valve seat of FIGS. 2A and 2B shown with the example second magnet.

FIG. 4C is a perspective view of the example second magnet of FIGS. 2A and 2B.

FIG. 5A is a perspective view of an example second valve trim assembly of FIGS. 1A and 1B.

FIG. 5B is an exploded view of the example second valve trim assembly of FIG. 5A.

FIG. 6 is a cross-sectional view of the example relief valve of FIGS. 1A and 1B.

FIG. 7 is a perspective view of another example relief valve disclosed herein.

FIG. 8A is a perspective view of an example first valve trim assembly of the example relief valve of FIG. 7.

FIG. 8B is an exploded view of the example first valve trim assembly of FIG. 8A.

FIG. 9 is a perspective view of an example first valve seat of FIGS. 8A and 8B.

FIG. 10A is a perspective view of an example second valve trim assembly of the example relief valve of FIG. 7.

FIG. 10B is an exploded view of the example second valve trim assembly of FIG. 10A.

FIG. 11 is a cross-sectional view of the example relief valve of FIG. 7.

FIG. 12 is a perspective, cross-sectional view of another example relief valve disclosed herein.

FIG. 13 is a front, cross-sectional view of another example relief valve disclosed herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Pressure systems (e.g., pressure lines, pressure vessels and/or piping systems) often include relief valves to protect the pressure system (e.g., a pressure vessel and/or pressure line) from pressure and/or vacuum buildup. The relief valves (e.g., pressure relief valves, vacuum relief valves, etc.) are self-actuated devices set to open when a pressure in the pressure system (e.g., the pressure vessel or pressure line) exceeds a pre-set pressure or level. For example, some fluids such as oil and gas are typically stored in large storage vessels. These fluids may emit vapor emissions that could over-pressurize the storage vessel. Therefore, a pressure relief valve can be connected to the storage vessel. If the pressure in the storage vessel exceeds the pre-set pressure, the pressure relief valve opens (e.g., to the atmosphere) to vent the vapor or gas buildup. Vacuum relief valves can similarly operate to protect against a vacuum or negative pressure in the storage vessel. If a pressure drop in the storage vessel causes a vacuum or an under-pressure condition, the vacuum relief valve emits atmospheric air to increase a pressure in the vessel. Some relief valves include both a pressure relief valve and a vacuum relief valve.

Relief valves often employ biasing elements to adjust and/or pre-set the set pressure of a relief valve. In some examples, weight-loaded relief valves employ weights to vary and/or adjust a desired a set pressure of the relief valve. In some examples, relief valves can employ a combination of weights and biasing elements to achieve a desired set pressure. Due to the high density of lead, relief valves often employ weights that include lead. In this manner, due to the density of lead compared to a density of other materials such as aluminum or other lead-free material(s) or alloy(s), weights that include lead require less volume to achieve a same set pressure compared to weights that are lead-free. However, weights that include lead negatively impact and/or pollute the environment.

Examples disclosed herein employ magnet-loaded relief valves. More specifically, example relief valves disclosed herein employ magnets to adjust a set pressure of a relief valve (e.g., a pressure relief valve, a vacuum relief valve, etc.). In some examples, example relief valves disclosed herein employ one or more magnets to provide a set pressure of a relief valve in lieu of lead-based weights. Thus, examples disclosed herein can eliminate the need for lead-based weights and improve the environment. Some example relief valves disclosed herein employ magnets to improve an opening efficiency (e.g., a speed) of a flow control member. Thus, in some examples, magnet assemblies disclosed herein engage when a relief valve is in a closed position and disengage when the relief valve is in an open position. In some examples, magnet assemblies disclosed herein disengage when a relief valve is in a closed position and engage when a relief valve is in an open position.

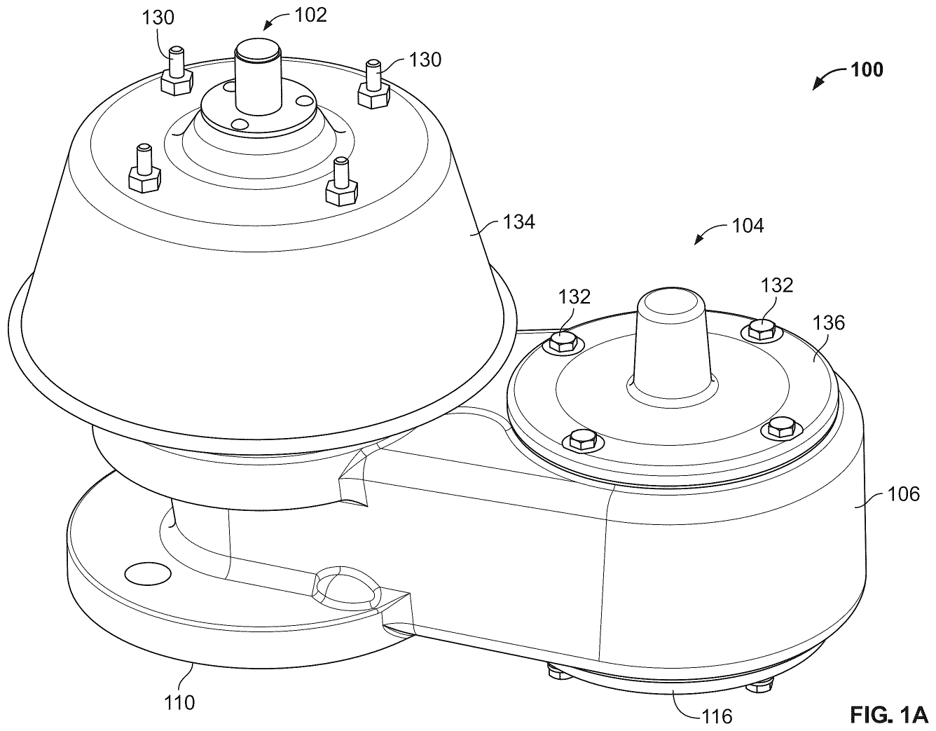

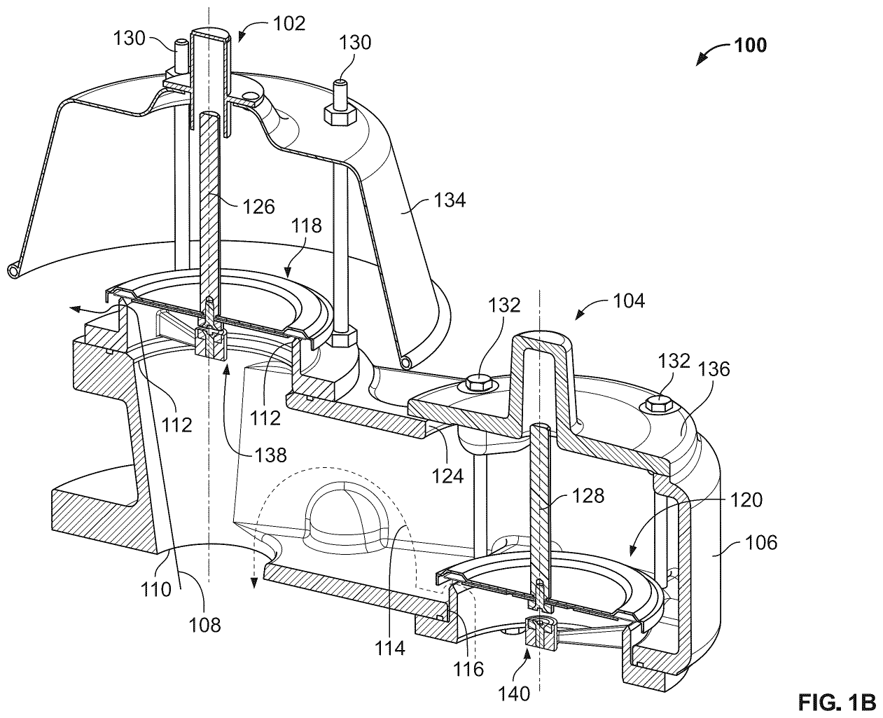

FIG. 1A is a perspective view of an example relief valve 100 in accordance with teachings of this disclosure. FIG. 1B is a perspective, cross-sectional view of the example relief valve 100 of FIG. 1A. The relief valve 100 of the illustrated example is a combination of a pressure relief valve 102 (e.g., a first relief valve) and a vacuum relief valve 104 (e.g., a second relief valve). For example, the relief valve 100 of FIGS. 1A and 1B can be used to prevent or reduce (e.g., excessive) pressure or vacuum buildup in a container or tank (e.g., a sealed container or tank) and/or other pressure system (e.g., a process pipe, a storage tank, etc.).

The relief valve 100 of the illustrated example includes a valve body 106 (e.g., a monolithic or one-piece valve body) defining a first passageway or first flow path 108 between a first port 110 (e.g., a system-side port, a first inlet port, a pressurized port) and a second port 112 (e.g., an exhaust port, an outlet port, a vent port). The valve body 106 of the illustrated example defines a second passageway or second flow path 114 between a third port 116 (e.g., an atmospheric port, a second inlet port) and the first port 110 (e.g., a second outlet port). The first port 110 is to be coupled to a pressure system, such as a sealed container or tank, a process pipe, etc. The pressure relief valve 102 controls the flow of fluid through the second port 112, and the vacuum relief valve 104 controls the flow of fluid through the third port 116. To control fluid flow through the first flow path 108 between the first port 110 and the second port 112, the pressure relief valve 102 of the relief valve 100 of the illustrated example includes a first valve trim assembly 118. To control fluid flow through the second flow path 114 between the third port 116 and the first port 110, the vacuum relief valve 104 of the relief valve 100 of the illustrated example includes a second valve trim assembly 120.

The first valve trim assembly 118 couples to the valve body 106 via the second port 112 and the second valve trim assembly 120 couples to the valve body 106 via a head port 124 of the valve body 106. The second port 112 is spaced laterally relative to the head port 124. Likewise, the second port 112 aligns (e.g. coaxially aligns) with a first longitudinal axis 126 of the first port 110 and the head port 124 aligns (e.g., coaxially aligns) with a second longitudinal axis 128 of the third port 116. A plurality of first fasteners 130 (e.g., a plurality of partially threaded rods or bolts and nuts) couple the first valve trim assembly 118 and the valve body 106. A plurality of second fasteners 132 (e.g., a plurality of partially threaded rods, bolts, nuts, etc.) couple the second valve trim assembly 120 and the valve body 106. The relief valve 100 includes a weather hood 134 coupled to the valve body 106 to cover the first valve trim assembly 118. The second valve trim assembly 120a includes a cover 136 that couples the valve trim assembly 118 and the valve body 106.

To provide a pressure-relief set point for the pressure relief valve 102, the example first valve trim assembly 118 of the illustrated example includes a first magnet assembly 138. To provide a vacuum-relief set point for the relief valve 100, the second valve trim assembly 120 of the illustrated example includes a second magnet assembly 140. The first magnet assembly 138 is spaced apart by a distance (e.g., a horizontal distance) from the second magnet assembly 140 such that the first magnet assembly 138 does not interfere or affect an operation of the second magnet assembly 140, and vice versa. In some examples, the first valve trim assembly 118 and/or the second valve trim assembly 120 does not include weights and/or biasing elements (e.g., springs). In some examples, the first valve trim assembly 118 and/or the second valve trim assembly 120 can include weights (e.g., non-lead based blocks, aluminum blocks) and/or a biasing element to assist with closing the respective pressure relief valve 102 and the vacuum relief valve 104.

Although the example relief valve 100 of the illustrated example is a dual pressure/vacuum pressure relief valve, the example pressure relief valve 102 and the vacuum relief valve 104 can be discrete, separate or isolated relief valves. For example, each of the pressure relief valve 102 and the vacuum relief valve 104 can have a dedicated valve body such that each of the pressure relief valve 102 and the vacuum relief valve 104 are fluidly isolated and/or physically separated from each other. Unlike known pressure and/or vacuum relief valves, the relief valve 100 of the illustrated example includes lead-free components (e.g., weights).

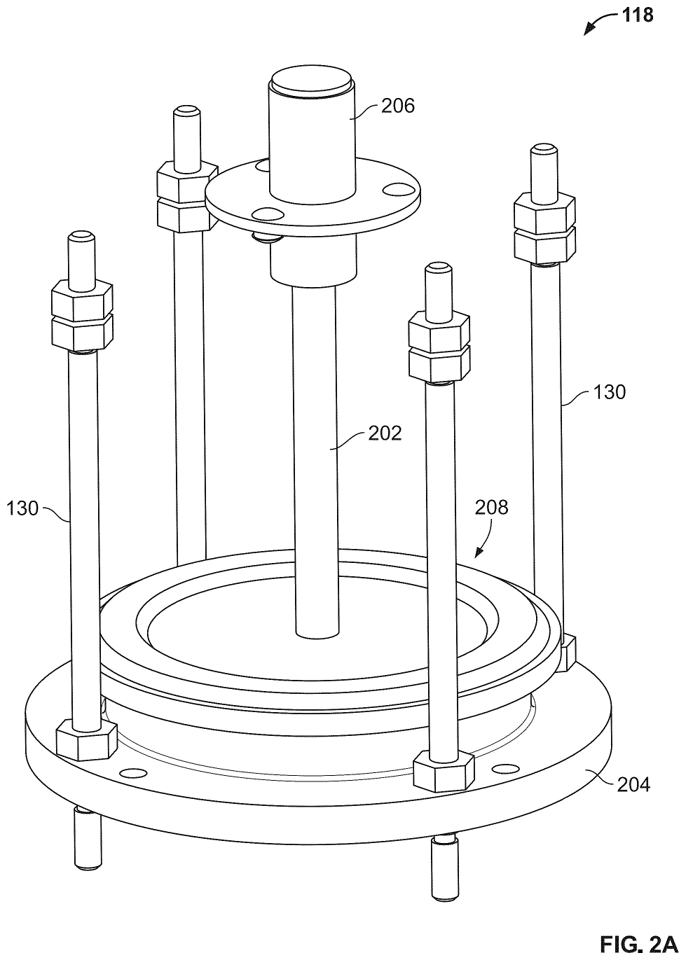

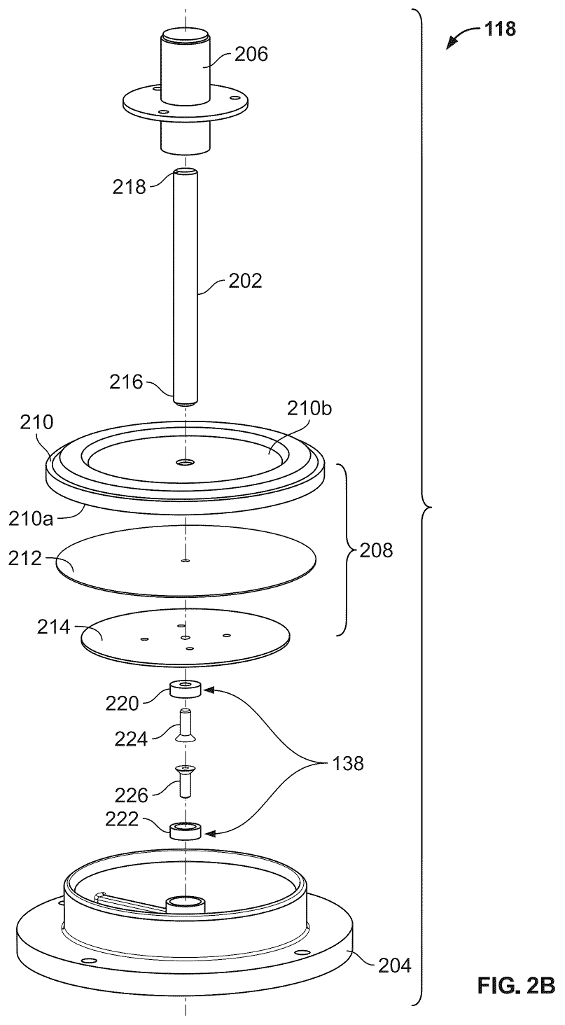

FIG. 2A is a perspective view of the first valve trim assembly 118 of FIGS. 1A and 1B. FIG. 2B is an exploded view of the first valve trim assembly 118 of FIG. 2A. Referring to FIGS. 2A and 2B, the first valve trim assembly 118 includes a first valve stem 202, a first valve seat 204, a first stem guide 206, a first flow control assembly 208 and the first magnet assembly 138. The first flow control assembly 208 includes a first pallet 210, a first gasket 212, and a first retainer 214. The first retainer 214 couples the first gasket 212 to a first side 210a of the first pallet 210. The first valve stem 202 includes a first end 216 that couples to a second side 210b of the first pallet 210 (e.g., opposite the first side 210a) and a second end 218 opposite the first end 216 that is slidably received in the first stem guide 206. The first stem guide 206 couples to the weather hood 134 of FIG. 1A and guides movement of the first valve stem 202 during operation of the pressure relief valve 102 of the relief valve 100.

The first magnet assembly 138 of the illustrated example includes a first magnet 220 and a second magnet 222. The first magnet 220 is coupled to the first valve stem 202 and the second magnet 222 is coupled to the first valve seat 204. For instance, the first magnet 220 is coupled to the first flow control assembly 208 via a first fastener 224 (e.g., a first screw) and the second magnet 222 is coupled to the first valve seat 204 via a second fastener 226 (e.g., a second screw). Additionally, the polarities of the first magnet 220 and the second magnet 222 are oriented such that the first magnet 220 is attracted to the second magnet 222 (e.g., an attractive force between the magnets increases as a distance between the magnets decreases).

The amount or level of pressure of the pressure set point of the pressure relief valve 102 is established based on a magnetic or attractive force between the first and second magnets 220, 222. For example, the attractive force of the first and second magnets 220, 222 can be provided based on a size and/or magnetic strength (e.g., magnetic material(s)) of the first magnet 220 and the second magnet 222. For example, the first magnet 220 and the second magnet 222 can provide an attractive force corresponding to a pressure set point of approximately between 1.0 (pound/square inch gauge (psig)) and 2.0 (psig) (e.g., 1.5 psig). The first magnet assembly 138 can be configured to provide any desired pressure set point based on a size (e.g., a diameter) and/or magnetic strength of the first magnet 220 and the second magnet 222. In some examples, the first magnet 220 and the second magnet 222 are identical (e.g., the first and second magnets 220, 222 are composed of the same material and have the same diameter). The first magnet 220 and the second magnet 222 are permanent magnets (i.e., magnets that retain magnetism over a large period of time). The first and second magnets 220, 222 can be made ferrite magnets, neodymium magnets, and/or any other type of magnet(s).

In some examples, the first magnet 220 can have a size (e.g., an area, a diameter, a shape, etc.) and/or material (e.g., a ferrite magnet) and the second magnet 222 can have a size (e.g., an area, a diameter, a shape, etc.) and/or material (e.g., an iron boron magnet) different that the size and/or material of the first magnet 220. In some examples, the first magnet 220 and/or the second magnet 222 can be a plurality of magnets (e.g., two or more stacked magnets). The first magnet 220 and the second magnet 222 of the illustrated example have a cylindrical shape. In other examples, the first magnet 220 and/or the second magnet 222 can have any other shape including, for example, a square shape, a rectangular shape, a triangular shape, an oblong shape, and/or any other shape or profile.

In some examples, a non-magnetic material or spacer can be positioned between the first magnet 220 and the second magnet 222 to vary (e.g., adjust or reduce) a force between the first magnet 220 and the second magnet 222 and, thus, to vary the pressure set point of the pressure relief valve 102. For example, a spacer (e.g., a washer, a disk, or other structure) composed of a non-ferrous, non-ferromagnetic material (e.g., plastic, rubber, aluminum, etc.) can be positioned between the first magnet 220 and the second magnet 222 to reduce an attractive force between the first and second magnets 220, 222. In some examples, the relief valve 100 of the illustrated example can include only the first magnet 220 or the second magnet 222. For example, the first magnet 220 or the second magnet 222 can be replaced with a non-ferrous material including, for example, iron, steel, nickel, cobalt, non-ferrous material(s), and/or non-ferrous alloy(s).

In some examples, the first magnet 220 or the second magnet 222 can be omitted and/or replaced with a structure (e.g., cylindrical body) that can be made of iron, steel, nickel, cobalt and/or other magnetophilic metal(s), alloy(s) and/or material(s) that can attract to a magnet. In such example, the first magnet assembly 138 includes only the first magnet 220 carried by the first flow control assembly 208 or the second magnet 222 carried by the first valve seat 204 that interacts with the structure to provide the pressure relief set point of the first trim assembly 118.

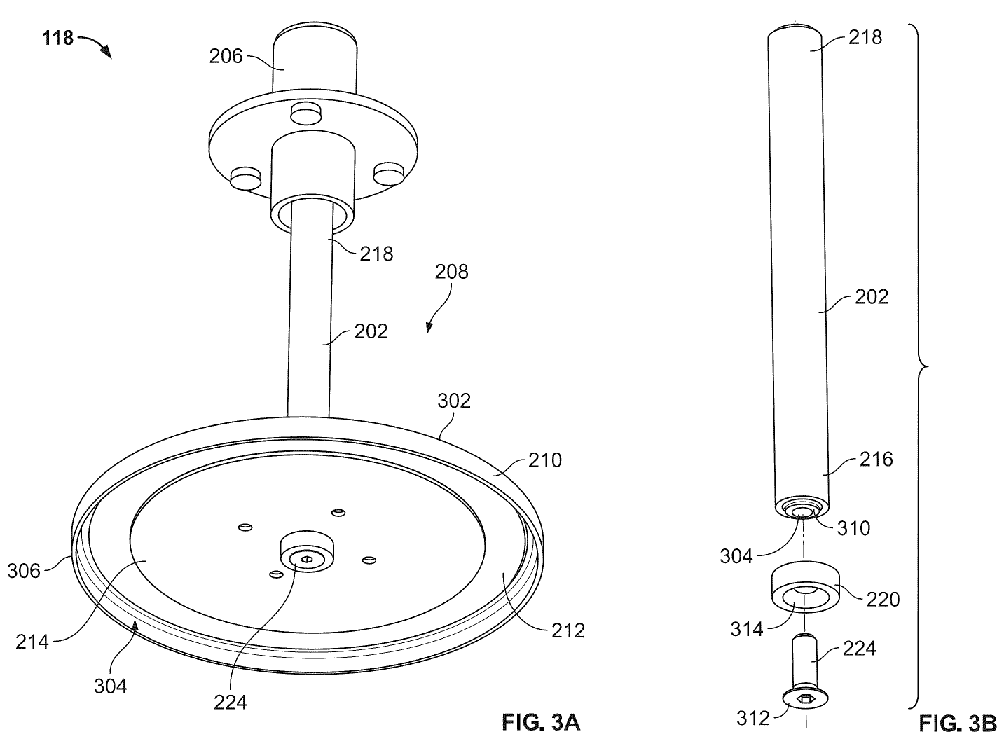

FIG. 3A is a perspective view of the first flow control assembly 208 of FIGS. 2A and 2B. FIG. 3B is a perspective, exploded view of the first valve stem 202, the first magnet 220, and the first fastener 224 of FIGS. 2A and 2B. Referring to FIGS. 3A and 3B, the first magnet 220 is coupled to the first end 216 of the first valve stem 202 via the first fastener 224. Specifically, the first magnet 220 is positioned beneath the first retainer 214 of the first flow control assembly 208. For example, the first pallet 210 of the illustrated example defines a cylindrical body 302 having a cavity 304 defining an annular lip 306. The cavity 304 of the first pallet 210 is oriented toward the first valve seat 204 (FIG. 2B). The first gasket 212, the first retainer 214, and the first magnet 220 are positioned in the cavity 304 of the first pallet 210. The first gasket 212 and the first retainer 214 are positioned between the first magnet 220 and the first pallet 210. The first magnet 220 of the illustrated example is coaxially aligned with a longitudinal axis 308 of the first valve stem 202. The first end 216 of the first valve stem 202 includes a protruding boss 310 (e.g., formed by an annular recess or groove) to receive the first fastener 224. The protruding boss 310 is to be inserted into an opening of the first pallet 210. Additionally, the first magnet 220 of the illustrated example includes a countersink bore 314 to receive a head 312 of the first fastener 224 to flush mount the first fastener 224 with the first magnet 220. The first fastener 224 of the illustrated example is a screw and threadably couples to the first end 216 of the first valve stem 202. In other example, the first fastener 224 can be a pin, a rivet, a clamp, and/or any other fastener. The second end 218 of the first valve stem 202 is received by the first stem guide 206.

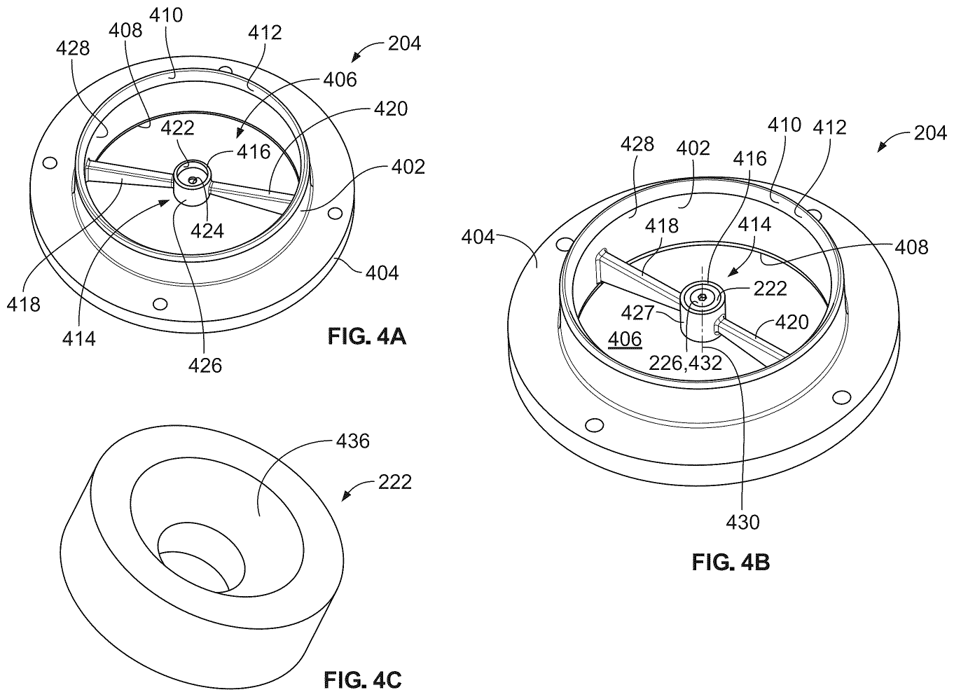

FIG. 4A is a perspective view of the first valve seat 204 of FIGS. 2A and 2B shown without the second magnet 222. FIG. 4B is a perspective view of the first valve seat 204 of FIGS. 2A and 2B shown with the second magnet 222. FIG. 4C is a perspective view of the second magnet 222 of FIGS. 2A and 2B. The first valve seat 204 of the illustrated example has a body 402 (e.g., a cylinder) and a flange 404 extending radially outward from the body 402. The body 402 defines an orifice 406 between a first side 408 of the body 402 and a second side 410 of the body 402 opposite the first side 408. The second side 410 of the first valve seat 204 defines a first seating surface 412.

The first valve seat 204 of the illustrated example includes a first magnet holder 414. The first magnet holder 414 of the illustrated example includes a boss 416 (e.g., a cylinder) supported by a first rib 418 (e.g., a first beam) and a second rib 420 (e.g., a second beam). In the illustrated example, the boss includes a recess 422 to receive at least a portion of the second magnet 222 and an aperture 424 (e.g., a threaded aperture) to receive the second fastener 226. The first rib 418 and the second rib 420 are spaced (e.g., circumferentially spaced) relative to the boss 416. For example, the first rib 418 and the second rib 420 extend between an outer surface 427 of the boss 416 and an inner surface 428 of the body 402. The first rib 418 and the second rib 420 support and/or suspend the boss 416 within the orifice 406 (e.g., between the first side 408 and the second side 410). In the illustrated example, the boss 416 is coaxially aligned with a longitudinal axis 430 of the first valve seat 204. Thus, the first rib 418 has a first length (e.g., a longitudinal length) that is substantially similar or equal to a second length (e.g., a longitudinal length) of the second rib 420. However, in some examples, the boss 416 can be offset relative to the longitudinal axis 430 of the first valve seat 204. For example, the first rib 418 can have a first length (e.g., a longitudinal length) that is different than (e.g., larger or smaller than) a second length (e.g., a longitudinal length) of the second rib 420. In other examples, the first valve seat 204 may include only one rib (e.g., on the first rib 418) or may include more than two ribs. In the illustrated example, a head 432 of the second fastener 426 is flush mounted relative to the second magnet 222 and the boss 416. The second magnet 222 of the illustrated example includes a countersink bore 436 to receive the head 432 of the second fastener 226.

In some examples, the first valve seat 204, the boss 416 and/or the first and second ribs 418, 420 can be composed of plastic, metal, aluminum, copper, non-ferrous material(s), and/or any other material(s) and/or alloy(s). In some examples, the second magnet 222 can be omitted and the boss 416 can be made of iron, steel, nickel, cobalt and/or other magnetophilic metal(s), alloy(s) and/or material(s) that can attract to a magnet (e.g., the first magnet 220). In such example, the first magnet assembly 138 includes only the first magnet 220 and the first magnet 220 interacts with the boss 416 to provide a pressure relief set point of the first trim assembly 118.

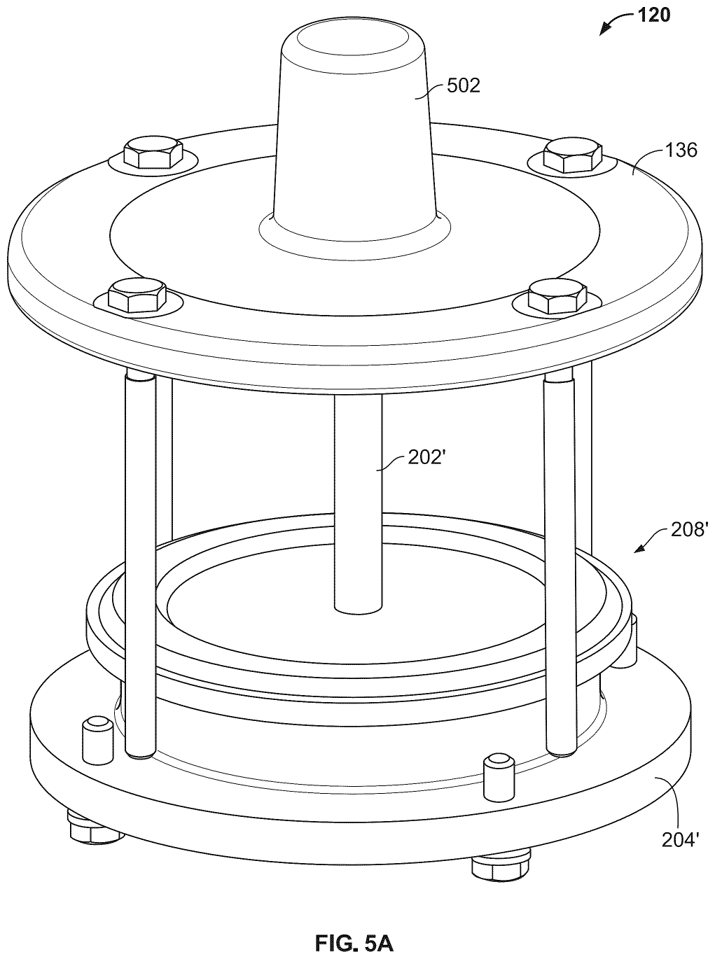

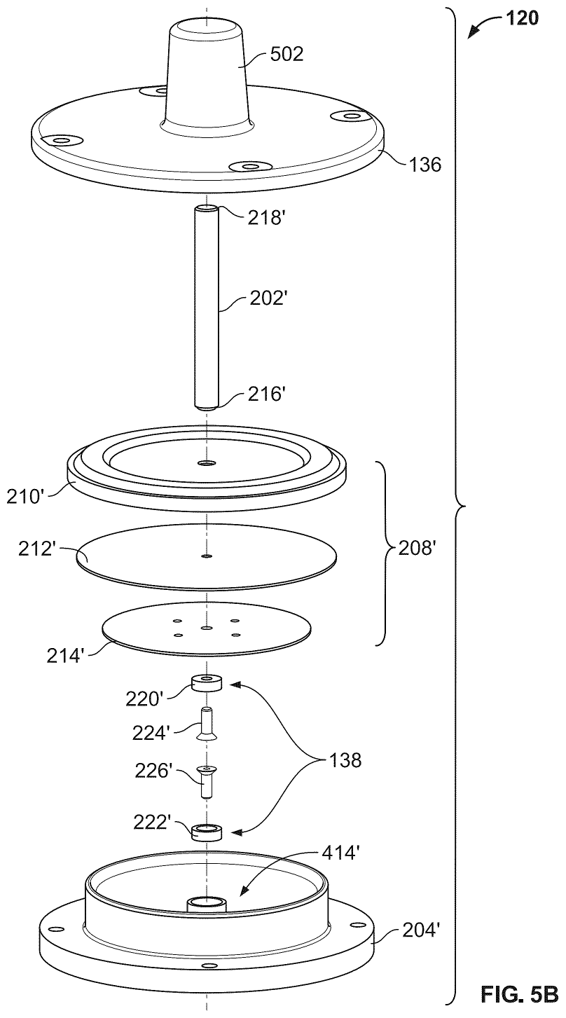

FIG. 5A is a perspective view of the second valve trim assembly of FIGS. 1A and 1B. FIG. 5B is an exploded view of FIG. 5A. The second valve trim assembly 120 of the illustrated example is substantially similar to the first valve trim assembly 118. For example, the components of the second valve trim assembly 120 have shapes that are similar to the shapes of the components of the first valve trim assembly 118. However, a size (e.g., a dimensional envelope, diameter, area, etc.) of one or more components of the second valve trim assembly 120 may be different (e.g., smaller than) or identical to a size of one or more components of the first valve trim assembly 118. In the illustrated example, components of the second valve trim assembly 120 that are similar or identical to components of the first valve trim assembly 118 will include reference numerals that are similar to the reference numerals of the components of the first valve trim assembly 118 with the addition of a prime character (′) associated with the reference numeral.

For example, referring to FIGS. 5A and 5B, the second valve trim assembly 118 of the illustrated example includes a second valve stem 202′, a second valve seat 204′, a second stem guide 502, a second flow control assembly 208′ and the second magnet assembly 140. The second flow control assembly 208′ includes a second pallet 210′, a second gasket 212′, and a second retainer 214′. The second retainer 214′ couples the second gasket 212′ to the second pallet 210′. The second valve stem 202′ includes a first end 216′ that couples to the second pallet 210′ and a second end 218′ opposite the first end 216′ that slidably couples to (e.g., is slidably received by a cavity or opening of) the second stem guide 502. The second stem guide 502 of the illustrated example is integrally formed with the vacuum cover 136, which couples to the valve body 106 as shown in FIGS. 1A and 1B.

The second magnet assembly 140 of the illustrated example provides the vacuum relief set point for the vacuum relief valve 104. The second magnet assembly 140 of the illustrated example includes a third magnet 220′ and a fourth magnet 222′. The third magnet 220′ is coupled to the second valve stem 202′ and the fourth magnet 222′ is coupled to the second valve seat 204′. For instance, the third magnet 220′ is coupled to the second flow control assembly 208′ via a first fastener 224′ (e.g., a first screw, a threaded screw) and the fourth magnet 222′ is coupled to the second valve seat 204′ via a second fastener 226′ (e.g., a second screw, a threaded screw). Specifically, the second valve seat 204′ includes a second magnet holder 414′ to receive the fourth magnet 222′. Moreover, the third magnet 220′ is oriented relative to the fourth magnet 222′ such that the third and fourth magnets 220′, 222′ provide an attractive force therebetween.

The vacuum set point is established based on a magnetic or attractive force between the third magnet 220′ and the fourth magnet 222′. For example, the attractive force of the third and fourth magnets 220′, 222′ can be provided based on a size and/or magnetic strength (e.g., magnetic material(s)) of the third magnet 220′ and the fourth magnet 222′. For example, the third magnet 220′ and the fourth magnet 222′ can provide an attractive force that can provide a vacuum relief set point of approximately between −1.0 (pound/square inch gauge (psig)) and −2.0 (psig) (e.g., −1.5 psig). The second magnet assembly 140 can be configured to provide any desired pressure set point based on a size (e.g., a diameter) and/or magnetic strength of the third magnet 220′ and the fourth magnet 222′. The third magnet 220′ and the fourth magnet 222′ of the illustrated example are identical (e.g., the third and fourth magnets 220′, 222′ are composed of the same material and have the same diameter). The third magnet 220′ and the fourth magnet 222′ are permanent magnets (i.e., magnets that retain magnetism over a large period of time). The third and fourth magnets 220′, 222′ can be made ferrite magnets, neodymium magnets, and/or any other type of magnet(s).

In some examples, the third magnet 220′ can have a size (e.g., an area, a diameter, a shape, etc.) and/or material (e.g., a ferrite magnet) and the fourth magnet 222′ can have a size (e.g., an area, a diameter, a shape, etc.) and/or material (e.g., an iron boron magnet) different that the size and/or material of the third magnet 220′. In some examples, the third magnet 220′ and/or the fourth magnet 222′ can be a plurality of magnets (e.g., two or more stacked magnets). The third magnet 220′ and the fourth magnet 222′ of the illustrated example have a cylindrical shape. In other examples, the third magnet 220′ and/or the fourth magnet 222′ can have any other shape including, for example, a square shape, a rectangular shape, a triangular shape, an oblong shape, and/or any other shape or profile. In some examples, the second magnet assembly 140 can be identical to the first magnet assembly 138. In some examples, the first magnet 220 and/or the second magnet 222 of the first magnet assembly 138 can be different than the third magnet 220′ and/or the fourth magnet 222′ of the second magnet assembly 140.

In some examples, a non-magnetic material or spacer can be positioned between the third magnet 220′ and the fourth magnet 222′ to adjust (e.g., reduce) a magnetic or attractive force between the third magnet 220′ and the fourth magnet 222′. For example, a spacer (e.g., a washer, a disk, or other structure) composed of a non-ferrous, non-ferromagnetic material (e.g., plastic, rubber, aluminum, etc.) can be positioned between the third magnet 220′ and the fourth magnet 222′.

In some examples, the third magnet 220′ or the fourth magnet 222′ can be replaced with a non-ferrous material including, for example, iron, steel, nickel, cobalt, and/or any other non-ferrous material(s) and/or alloy(s). In some examples, the third magnet 220′ can be omitted and/or replaced with a structure (e.g., cylindrical body) that can be made of iron, steel, nickel, cobalt and/or other magnetophilic metal(s), alloy(s) and/or material(s) that can attract to a magnet. In such example, the second magnet assembly 140 includes only the fourth magnet 222′ carried by the second valve seat 204′ and the fourth magnet 222′ interacts with the structure to provide the vacuum relief set point of the second trim assembly 120. In some examples, the second valve seat 204′ and/or the second magnet holder 414′ can be composed of plastic, metal, aluminum, copper, non-ferrous material(s), and/or any other material(s) and/or alloy(s). In some examples, the fourth magnet 222′ can be omitted and the second valve seat 204′ and/or the second magnet holder 414′ can be made of iron, steel, nickel, cobalt and/or other magnetophilic metal(s), alloy(s) and/or material(s) that can attract to a magnet. In such example, the second magnet assembly 140 includes only the third magnet 220′ and the third magnet 220′ interacts with the second valve seat 204′ and/or the second magnet holder 414′ to provide the vacuum relief set point of the second trim assembly 120.

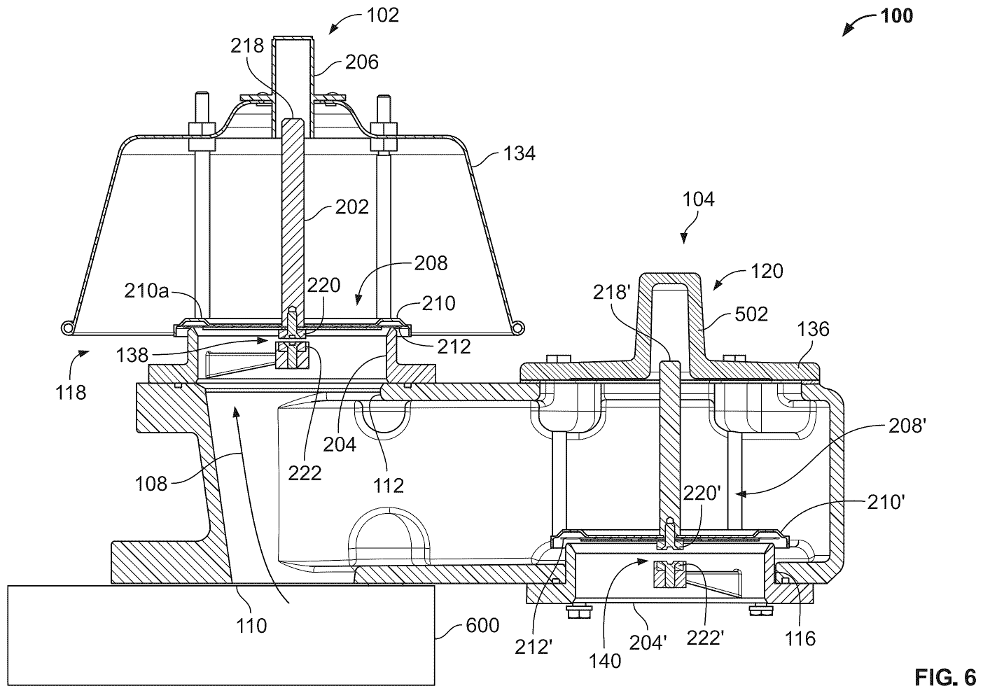

FIG. 6 is a cross-sectional view of the relief valve 100 of FIGS. 1A and 1B. The relief valve 100 can be fluidly coupled to a pressure system 600 (e.g., a storage tank or a pipeline) via a mounting flange 602 of the valve body 106 adjacent the first port 110. The first port 110 is in fluid communication with the fluid in the pressure system. As such, the pressure in the fluid passageway in the valve body 106 is the same as the pressure in the pressure system 600. In operation, the pressure relief valve 102 and the vacuum relief valve 104 are configured to stay in a normally closed position until a pressure of the pressure system 600 overcomes the pressure set point provided by the first magnet assembly 138 or the vacuum set point provided by the second magnet assembly 140. Thus, a pressure differential across the first flow control assembly 208 determines an operational position (e.g., an open position or a closed position) of the pressure relief valve 102 and a pressure differential across the second flow control assembly 208′ determines an operation position (e.g., an open position or a closed position) of the vacuum relief valve 104.

When a pressure of the pressure system 600 does not exceed the pressure relief set point (e.g., a pressure at which the pressure relief valve is set to open, e.g., 1.5 (psig))), the pressure relief valve 102 is in a first closed position. For example, in the first closed position, the first gasket 212 supported by the first pallet 210 of the pressure relief valve 102 sealingly engages the first valve seat 204 to prevent or restrict fluid flow between the first port 110 and the second port 112 provided by the first flow path 108. When a pressure of the pressure system 600 exceeds the pressure relief set point (e.g., a pressure provided by a fluid on the first side 210a of the first pallet 210 is greater than pressure relief set point), a pressure differential across the first pallet 210 causes first pallet 210 to move upward and away from the first valve seat 204 and, thus, the first magnet 220 coupled to the first valve stem 202 moves away (e.g., separate) from the second magnet 222 carried by the first valve seat 204 (e.g., in a rectilinear direction). In the open position, the first gasket 212 of the first pallet 210 of the pressure relief valve 102 is spaced from the first valve seat 204 to allow a fluid (e.g., steam, gas, air, etc.) to flow from the pressure system 600 to vent via the second port 112 of the relief valve 100. This flow of fluid continues (e.g., at a sufficient rate) to prevent a pressure in the pressure system 600 from rising above a predetermined level or above a specified overpressure (e.g., between approximately 1.5 psig and 15 psig). In some examples, a fluid of the pressure system 600 vents to the atmosphere via the second port 112. In some examples, a fluid (e.g., steam, gas, air, etc.) of the pressure system 600 vents to a pipe system coupled to the second port 112 (e.g., via an adaptor). When a pressure in the pressure system 600 reduces to a level below the pressure relief set point, the first pallet 210 of the pressure relief valve 102 moves toward the first valve seat 204 toward the closed position. As the first magnet 220 approaches the second magnet 222, the first and second magnets 220, 222 attract, thereby causing the first gasket 212 of the first pallet 210 to engage (e.g., sealingly engage) with the first valve seat 204 and thereby preventing or restricting additional flow from the pressure system 600. As the pressure reduces at or below the pressure set point, the weight of the first trim assembly 118 (e.g., the valve stem 202, the pallet 220, etc.) causes the pallet 220 to move toward the valve seat 204. In some examples, gravity can assist with movement of the first pallet 210 toward the first valve seat 204 when a pressure of the pressure system 600 decreases less than the pressure relief set point. Thus, the first pallet 210 automatically re-seats and has sealing contact with the first valve seat 204 as a pressure of the pressure system 600 reduces below the pressure relief set point provided by the first magnet assembly 138. Additionally, a pressure or force holding the first trim assembly 118 (e.g., the pallet 220) in a closed position is a combination of the magnetic attraction force of the first and second magnets 220, 222 and a weight of the stem 202 and/or flow control assembly 208.

Likewise, when a pressure of the pressure system 600 exceeds the vacuum relief set point (e.g., a pressure at which the pressure relief valve is set to open, −1.5 (psig))), the vacuum relief valve 104 is in a second closed position. For example, in the second closed position, the second gasket 212′ supported by the second pallet 210′ of the vacuum relief valve 104 sealingly engages the second valve seat 204′ to prevent or restrict fluid flow between the third port 116 and the first port 110 provided by the second flow path 114. When a pressure of the pressure system 600 does not exceed the vacuum relief set point (e.g., a pressure of the pressure system 600 does not exceed the vacuum relief set point provided by the second magnet assembly 140), a pressure differential across the second pallet 210′ causes the second pallet 210′ to move away from the second valve seat 204′ and, thus, the third magnet 220′ coupled to the second valve stem 202′ moves away (e.g., separate) from the fourth magnet 222′ carried by the second valve seat 204′ (e.g., in a rectilinear direction). In the second open position, the second gasket 212′ of the second pallet 210′ of the vacuum relief valve 104 is spaced from the second valve seat 204′ to allow a fluid (e.g., atmospheric air) to flow from the third port 116 to the pressure system 600 via the second flow path 114. This flow of fluid continues (e.g., at a sufficient rate) to prevent a pressure in the pressure system 600 from falling below a predetermined level or below a specified under-pressure condition (e.g., between approximately −1.5 psig and −15 psig). When a pressure in the pressure system 600 increases to a level above the vacuum relief set point, the second pallet 210′ of the vacuum relief valve 102′ moves toward the second valve seat 204′ to the second closed position. As the third magnet 220′ approaches the fourth magnet 222′, the third and fourth magnets 220′, 222′ attract, thereby causing the second gasket 212′ of the second pallet 210′ to engage (e.g., sealingly engage) with the second valve seat 204′ and thereby preventing or restricting additional flow from the third port 116 to the pressure system 600. In some examples, gravity can assist with movement of the second pallet 210′ toward the second valve seat 204′. Thus, the second pallet 210′ automatically re-seats and has sealing contact with the second valve seat 204′ as a pressure of the pressure system 600 increases above the vacuum relief set point provided by the second magnet assembly 140.

In some examples, the relief valve 100 of the illustrated example can include a biasing element and/or weights coupled to the first flow control assembly 208 and/or the second flow control assembly 208′. For example, a biasing element (e.g., a coil spring, a Bellville spring, a leaf spring, etc.) can be positioned in: (a) the first stem guide 206 to impart a biasing force on the second end 218 of the first valve stem 202 (e.g., a rectilinear force in a direction of the first valve seat 204); and/or (b) the second stem guide 502 to impart a biasing force on the second end 218′ of the second valve stem 202′ (e.g., a rectilinear force in a direction of the second valve seat 204′). In some examples, a biasing element (e.g., a coil spring) and/or one or more weights can be positioned between the weather hood 134 and the first pallet 210 to impart a force against the first pallet 210 (e.g., in a direction toward the first valve seat 204) and/or increase a pressure set point provided by the first magnet assembly 138. Similarly, a biasing element (e.g., a coil spring) and/or one or more weights can be positioned between the cover 136 and the second pallet 210′ to impart a force on the second pallet 210′ (e.g., in a direction toward the second valve seat 204′) and/or increase a pressure set point provided by the second magnet assembly 140.

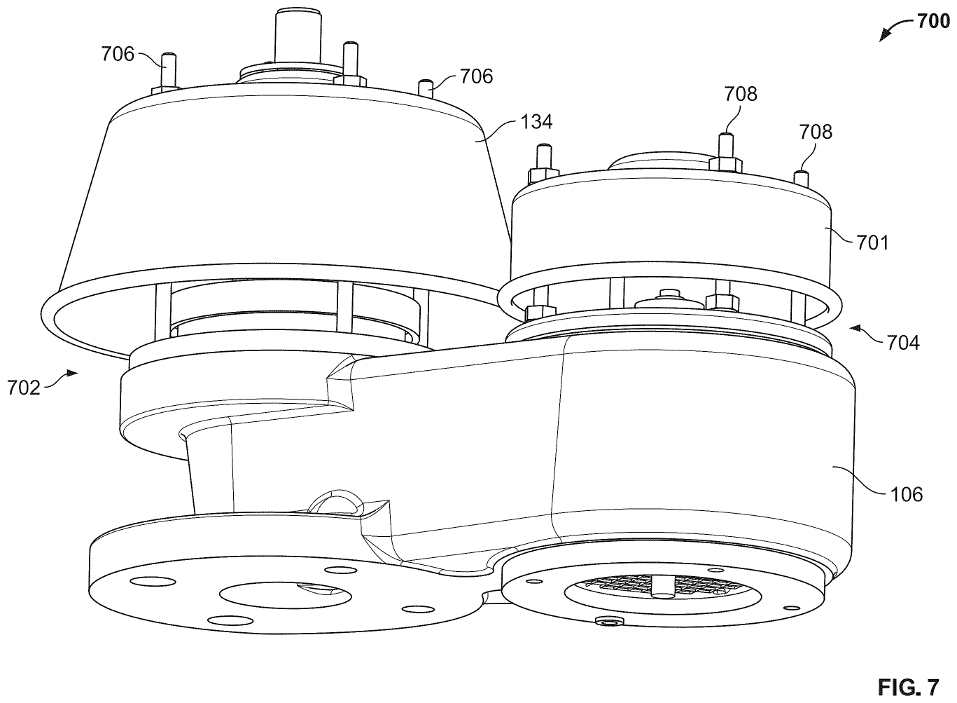

FIG. 7 is a perspective view of another example relief valve 700 disclosed herein. Many of the components of the example relief valve 700 of FIG. 7 are substantially similar or identical to the components described above in connection with FIGS. 1A and 1B. As such, those components will not be described in detail again below. Instead, the interested reader is referred to the above corresponding descriptions for a complete written description of the structure and operation of such components. To facilitate this process, similar or identical reference numbers will be used for like structures as used in FIGS. 1A-6 above. For example, the relief valve of FIG. 7 includes a pressure relief valve 702, a vacuum relief valve 704, and a valve body 106 that forms at least a portion of each of the pressure relief valve 702 and the vacuum relief valve 704. Additionally, the relief valve 700 of the illustrated example includes a weather hood 134 mounted to the valve body 106 to cover or protect the pressure relief valve 702 and a second weather hood 701 (e.g., a cover) mounted to the valve body 106 to cover or protect the vacuum relief valve 704. The weather hood 134 is coupled to the valve body 106 via a plurality of first mounting rods 706. The second weather hood 701 is coupled to the valve body 106 via a plurality of second mounting rods 708. In contrast to the example relief valve 100 described above, the relief valve 700 of the illustrated example employs one or more magnets to improve openability of the relief valve 700 (e.g., increase a speed at which the pressure relief valve 702 and/or the vacuum relief valve 704 move to an open position).

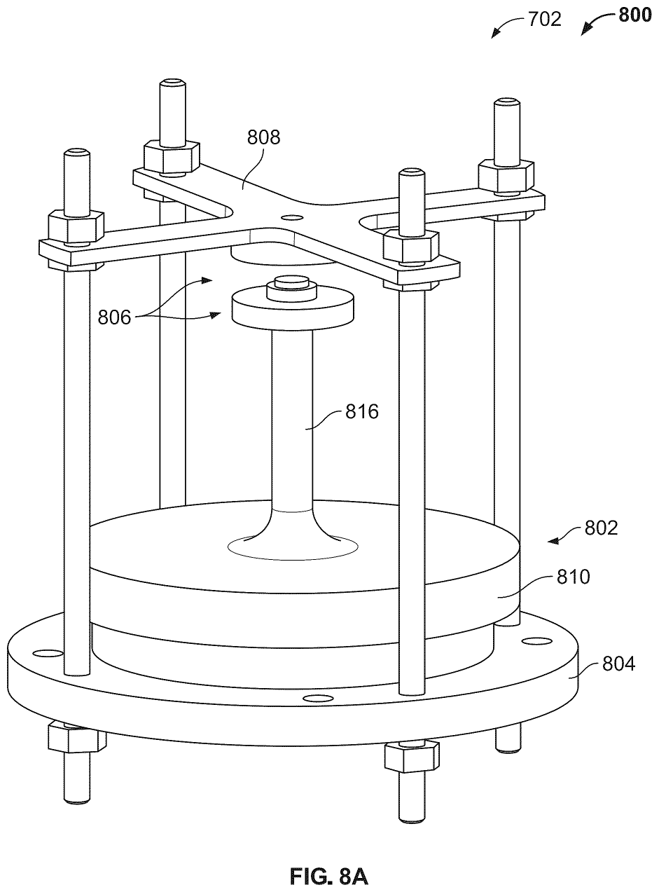

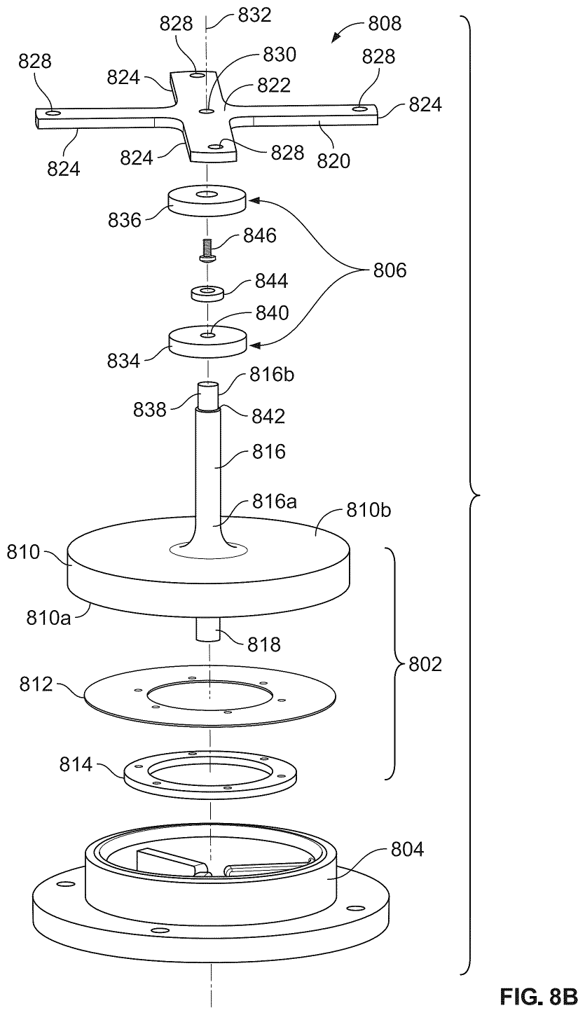

FIG. 8A is a perspective view of a first trim assembly 800 of the pressure relief valve 702 of FIG. 7. FIG. 8B is an exploded view of the first trim assembly 800 of FIG. 8A. The first trim assembly 800 of the illustrated example includes a first flow control assembly 802, a first valve seat 804, a first magnet assembly 806, and a first magnet holder 808. The first flow control assembly 802 includes a flow control member and/or first pallet 810, a first gasket 812, a first retainer 814, a first valve stem 816 and a first guide stem 818. The first guide stem 818 projects and/or is coupled to a first side 810a of the first pallet 810 and the first valve stem 816 projects and/or is coupled to a second side 810b of the first pallet 810 and opposite the first side 810a. In the illustrated example, the first valve stem 816 includes a first end 816a coupled to the first pallet 810 and a second end 816b opposite the first end 816a extending toward the first magnet holder 808. The first guide stem 818 protrudes from the first side 810a of the first pallet 810 toward the first valve seat 804. In the illustrated example, the first valve stem 816 and the first guide stem 818 are integrally formed with the first pallet 810 as a unitary structure or piece (e.g., a monolithic body). However, in other examples, the first valve stem 816 and/or the first guide stem 818 are separate parts that can be coupled to the first pallet 810 via pins, threads, welding, and/or any other manufacturing and/or fastening process(es).

The first magnet holder 808 of the illustrated example is a brace or bracket 820. The first magnet holder 808 of the illustrated example includes a central portion or hub 822 (e.g., a central hub or boss) and a plurality of arms 824 extending and/or cantilevered from the hub 822. Respective ends 826 of the arms 824 include openings 828 to receive respective ones of the first mounting rods 706. The first mounting rods 706 couple the first magnet holder 808 to the first valve seat 804 and/or the valve body 106. In particular, the first mounting rods 706 suspend the first magnet holder 808 relative to the first flow control assembly 802 (e.g., the first pallet 810 and/or the first valve seat 804). In the illustrated example, the first magnet holder 808 includes four arms 824. Thus, the first magnet holder 808 of the illustrated example has an X-shaped profile. However, in other examples, the first magnet holder 808 can include two arms, three arms, five arms and/or any other number of arms. Thus, in other examples, the first magnet holder 808 can have a triangular profile, a pentagon profile and/or any other suitable profile(s) and/or shape(s). Additionally, the first magnet holder 808 (e.g., the hub 822) includes a central opening 830. In the illustrated example, the hub 822 and/or the central opening 830 is coaxially aligned with a longitudinal axis 832 of the first flow control assembly 802.

The first magnet assembly 806 includes a first magnet 834 and a second magnet 836. The first magnet 834 of the illustrated example is coaxially aligned with the second magnet 836. The first magnet 834 and/or the second magnet 836 can be similar to the first magnet 220 and the second magnet 222 of the relief valve 100 described above in connection with FIGS. 1A and 1B. The first magnet 834 of the illustrated example is coupled to or carried by the second end 816b of the first valve stem 816. For example, the second end 816b of the first valve stem 816 includes an annular recess 838 to receive the first magnet 834. The second end 816b of the first valve stem 816 of the illustrated example has a reduced size (e.g., a diameter) compared to the first end 816a of the first valve stem 816. The first magnet 834 of the illustrated example includes a central aperture 840 to receive the second end 816b (e.g., the recessed end) of the first valve stem 816. The annular recess 838 forms a stop or a shoulder 842 to maintain and/or support a position of the first magnet 834 at the second end 816b of the first valve stem 816. A retainer 844 (e.g., a locking nut, a clamp, a fastener, etc.) secures or locks the first magnet 834 to the second end 816b of the first valve stem 816. Thus, the first magnet 834 is positioned (e.g., captured) between the retainer 844 and the shoulder 842 of the first valve stem 816.

The second magnet 836 is coupled to the first magnet holder 808. Specifically, the second magnet 836 is coupled to the hub 822 of the first magnet holder 808 via a fastener 846 (e.g., a screw, a threaded fastener). In other examples, the second magnet 836 can couple to the first magnet holder 808 via a rivet, a clamp and/or any other fastener(s). The second magnet 836 includes a second central opening 848 to receive the fastener 846. To couple the second magnet 836 and the first magnet holder 808, the central opening 830 of the hub 822 receives the fastener 846. Thus, the second magnet 836 is positioned (e.g., captured) between the fastener 846 and the first magnet holder 808. In the illustrated example, the second magnet 836 is oriented toward the first magnet 834.

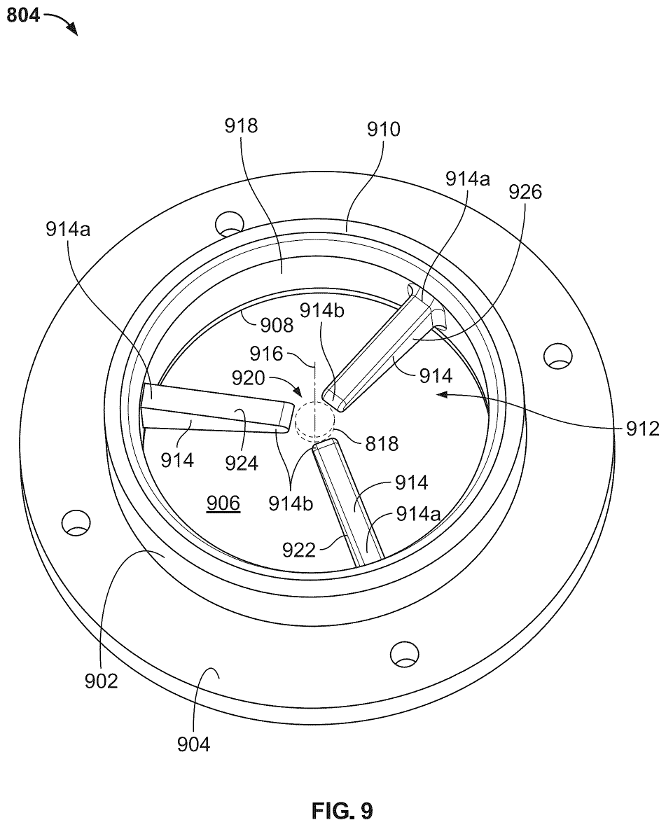

FIG. 9 is a perspective view of the first valve seat 804 of FIGS. 8A and 8B. The first valve seat 804 of the illustrated example has a body 902 (e.g., a cylinder) and a flange 904 extending radially outward from the body 902. The body 902 defines an orifice 906 between a first side 908 of the body 902 and a second side 910 of the body 902 opposite the first side 908. The first valve seat 804 of the illustrated example includes a first stem guide 912. The first stem guide 912 of the illustrated example includes a plurality of ribs 914 radially spaced relative to a longitudinal axis 916 of the first valve seat 804. Specifically, the ribs 914 of the illustrated example are cantilevered from an inner wall 918 of the body 902 of the first valve seat 804 and protrude toward a center of the body 902 or the longitudinal axis 916 of the first valve seat 804. For instance, each of the ribs 914 includes a first end 914a attached to the inner wall 918 of the body 902 and a second end 914b opposite the first end 914a suspended in the orifice 906. The respective second ends 914b of the ribs 914 define a guide opening 920 to receive the first guide stem 818 of the first flow control assembly 802 and/or the first pallet 810. Thus, the first stem guide 912 helps maintain the first flow control assembly 802 aligned (e.g., parallel and/or coaxially aligned) relative the longitudinal axis 916 of the first valve seat 804 and/or the longitudinal axis 832 of the first flow control assembly 802. The ribs 914 of the illustrated example include a first rib 922, a second rib 924 and a third rib 926. The first rib 922 has a first length (e.g., a longitudinal length) that is substantially similar to or equal to a second length (e.g., a longitudinal length) of the second rib 924 and a third length of the third rib 926. However, in some examples, the first rib 922 can have a first length that is different than (e.g., larger, or smaller than) a second length of the second rib 924 and/or a third length of the third rib 926. In some examples, the first stem guide 912 can include two ribs, four ribs, six ribs and/or any number of ribs.

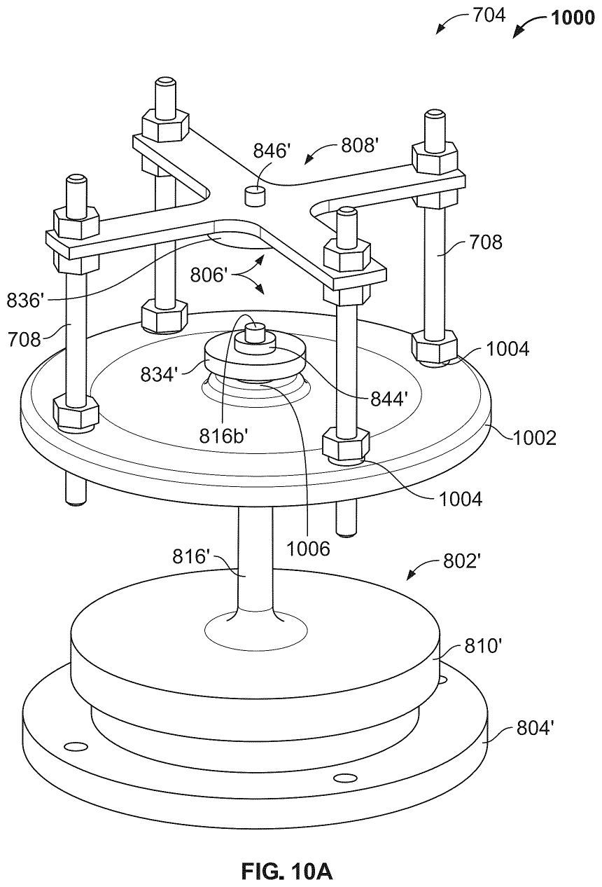

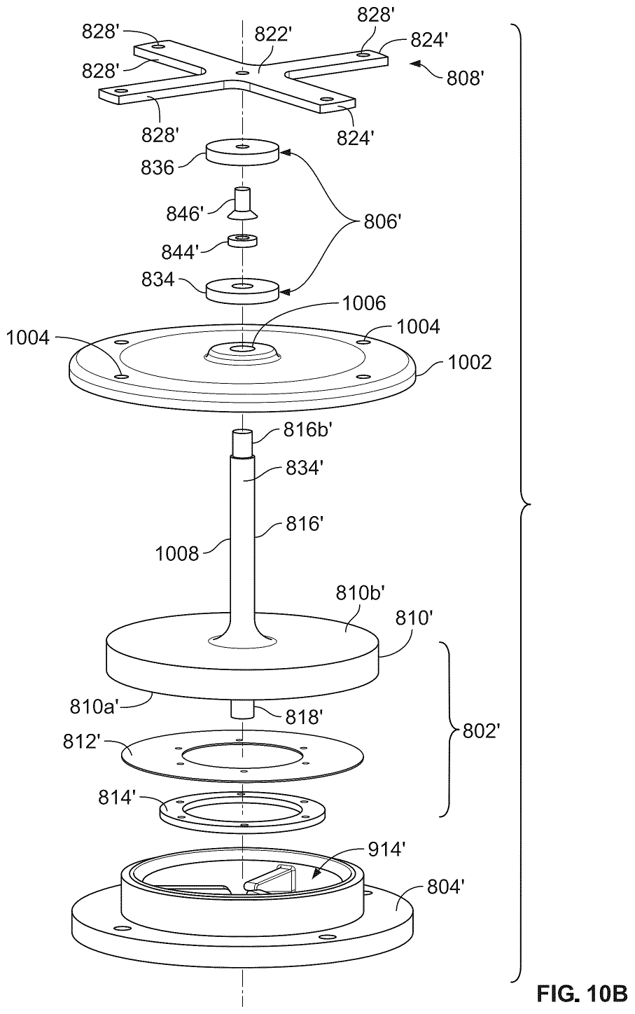

FIG. 10A is a perspective view of a second trim assembly 1000 of the vacuum relief valve 704 of FIG. 7. FIG. 10B is an exploded view of the second trim assembly 1000 of FIG. 10A. The second valve trim assembly 1000 of the illustrated example is substantially similar to the first valve trim assembly 800. For example, the components of the second valve trim assembly 1000 have shapes that are similar to the shapes of the components of the first valve trim assembly 800. However, a size (e.g., a dimensional envelope, diameter, area, etc.) of one or more components of the second valve trim assembly 1000 may be different (e.g., smaller than) or identical to a size of one or more components of the first valve trim assembly 800. In the illustrated example, components of the second valve trim assembly 1000 that are similar or identical to components of the first valve trim assembly 800 will include reference numerals that are similar to the reference numerals of the components of the first valve trim assembly 800 with the addition of a prime character (′) associated with the reference numeral. For example, the second trim assembly 1000 of the illustrated example includes a second flow control assembly 802′, a second valve seat 804′, a second magnet assembly 806′, and a second magnet holder 808′. The second flow control assembly 802′ includes a second flow control member and/or second pallet 810′, a second gasket 812′, a second retainer 814′, a second valve stem 816′ and a second guide stem 818′. The second valve stem 816′ projects and/or is coupled to a second side 810b′ of the second pallet 810′ and the second guide stem 818′ projects and/or is coupled to a first side 810a′ of the second pallet 810′ opposite the first side 810a′. The second valve seat 804′ includes a second stem guide 914′ to guide the second guide stem 818′ of the second pallet 810′.

The second magnet assembly 806′ includes a third magnet 834′ and a fourth magnet 836′. The third magnet 834′ of the illustrated example is coaxially aligned with the fourth magnet 836′. The third magnet 834′ and/or the fourth magnet 836′ can be similar to (e.g., identical to) the first magnet 834 and the second magnet 836 of the pressure relief valve 702 and/or the third magnet 220′ and the fourth magnet 222′ of the relief valve 100 described above in connection with FIGS. 1A and 1B. The third magnet 834′ of the illustrated example is coupled to (e.g., attached to) or carried by the second end 816b′ of the second valve stem 816′ via the second retainer 844′. The fourth magnet 836′ is coupled to the second magnet holder 808′. Specifically, the fourth magnet 836′ is coupled to a hub 822′ of the second magnet holder 808′ via a second fastener 846′ (e.g., a screw, a threaded fastener).

The second trim assembly 1000 of the illustrated example includes a cover 1002. The cover 1002 couples the second valve trim assembly 1000 and the valve body 106. For example, the cover 1002 receives respective ones of the second mounting rods 708 to couple to the valve body 106. The cover 1002 of the illustrated example includes a plurality of openings 1004 radially spaced relative to the second longitudinal axis 832′ to receive respective ones of the second mounting rods 708. The cover 1002 includes a central opening 1006 (e.g., a stem guide) to slidably receive the second valve stem 816′. For example, a size (e.g., a diameter) of the central opening 1006 configured to slidably receive an outer surface 1008 of the second valve stem 816′ (e.g., an outer surface of the second valve stem 816′ having the largest diameter). The cover 1002 supports the second valve stem 816′ as the second pallet 810′ moves between a first closed position and a first open position. Additionally, the cover 1002 of the illustrated example couples the second magnet holder 808′ to the valve body 106. Respective ends of the arms 824′ of the second magnet holder 808′ include openings 828′ to receive respective ones of second mounting rods 708. The second mounting rods 708 couple and/or suspends the second magnet holder 808′ relative to the third magnet 834′, the second valve seat 804′ and/or the valve body 106. In the illustrated example, a hub 822′ and/or a central opening 830′ of the second magnet holder 808′ is coaxially aligned with a second longitudinal axis 832′ of the second flow control assembly 802′.

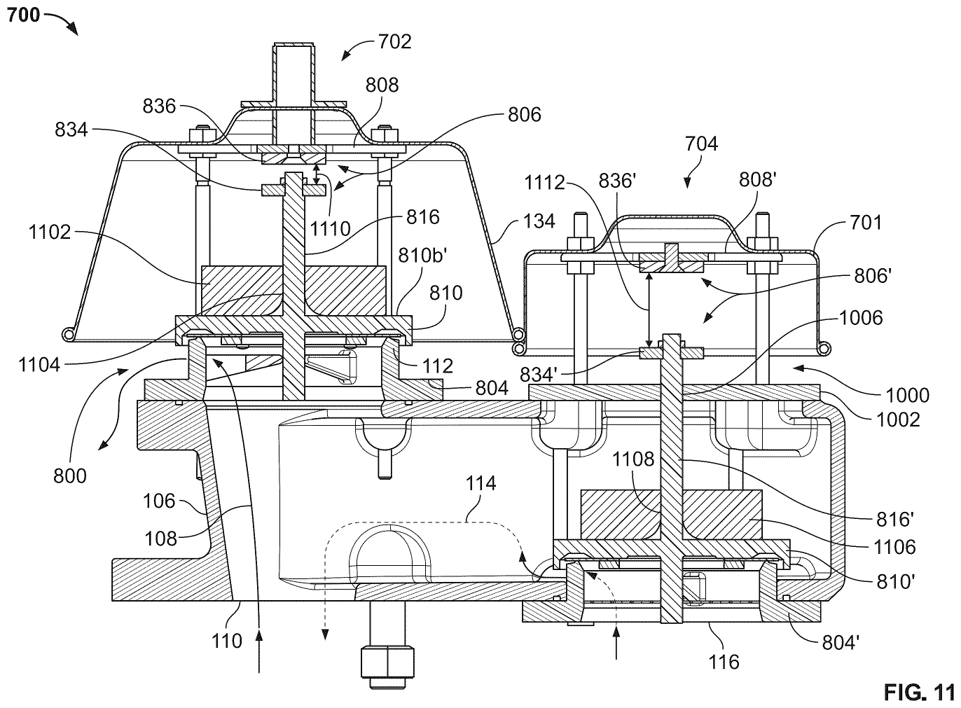

FIG. 11 is a cross-sectional view of the relief valve 700 of FIG. 7. The valve body 106 of the relief valve 700 defines a first flow path 108 between a first port 110 and a second port 112 and a second flow path 114 between a third port 116 and the first port 110. The pressure relief valve 702 controls fluid flow through the first flow path 108 and the vacuum relief valve 704 controls fluid through the second flow path 114.

In the illustrated example, the first valve stem 816 supports or suspends the first magnet 834 adjacent to the second magnet 836, and the first magnet holder 808 supports or suspends the second magnet 836 adjacent (e.g., above) the first magnet 834. The first magnet assembly 806 (e.g., the first and second magnets 834, 836) is positioned on the second side 810b of the first pallet 810. In other words, the first magnet assembly 806 of the illustrated example is positioned between the first pallet 810 and the weather hood 134. Thus, the first magnet assembly 806 is positioned between the first pallet 810 and the first magnet holder 808. Stated differently, the first magnet assembly 806 is positioned outside of the first flow path 108. In the illustrated example, the first magnet holder 808 is suspended downstream from the second port 112. To provide a pressure relief set point of the pressure relief valve 702, the pressure relief valve 702 of the illustrated example includes a first weight 1102. In the illustrated example, the first weight 1102 is positioned on the second side 810b of the first pallet 810. The first weight 1102 includes an aperture 1104 to receive (e.g., slidably receive) the first valve stem 816.

Similarly, the second valve stem 816′ supports or suspends the third magnet 834′ adjacent the fourth magnet 836′, and the second magnet holder 808′ supports or suspends the fourth magnet 836′ adjacent (e.g., above) the third magnet 834′. The second magnet assembly 806′ (e.g., the third and fourth magnets 834′, 836′) is positioned on the second side 810b′ of the second pallet 810′. In other words, the second magnet assembly 806′ of the illustrated example is positioned between the second pallet 810′ and the vacuum cover 136. Thus, the second magnet assembly 806′ is positioned between the second pallet 810′ and the second magnet holder 808′. Stated differently, the second magnet assembly 806′ is positioned outside of the second flow path 114. To provide a vacuum relief set point of the vacuum relief valve 704, the vacuum relief valve 704 of the illustrated example includes a second weight 1106. The second weight 1106 can be substantially similar to the first weight 1102. The second weight 1106 can be positioned on the second side 810b′ of the second pallet 810′. The second weight 1106 includes an aperture 1108 to receive (e.g., slidably receive) the second valve stem 816′.

In operation, the first weight 1102 causes the first pallet 810 to engage (e.g., sealingly engage) the first valve seat 804 when a pressure of a fluid of a pressure system (e.g., the pressure system 600) is less than a pressure set point provided by the first weight 1102. In a closed position, the first magnet 834 is spaced from and/or disengaged from the second magnet 836 by a first distance 1110 (e.g., a maximum vertical distance in the orientation of FIG. 11) that reduces or prevents an attractive force between the first magnet 834 and the second magnet 836 (e.g., the first magnet 834 provides zero or negligible attractive force on the second magnet 836). When the pressure of the fluid of the pressure system increases to a pressure that exceeds the pressure set point, the pressurized fluid causes the first pallet 810 to move away from the first valve seat 804 to allow fluid flow through the first flow path 108. As a result, the first pallet 810 and, thus, the first magnet 834 move in a rectilinear direction toward the second magnet 836. As the first distance 1110 between the first magnet 834 and the second magnet 836 decreases, a magnetic force between the first and second magnets 834, 836 increases. Thus, a magnetic force between the first magnet 834 and the second magnet 836 is greater when the first pallet 810 is spaced from the first valve seat 804 than when the first pallet 810 is in engagement with the first valve seat 804. As a result, the first magnet 834 attracts to the second magnet 836 and helps move the first pallet 810 to an open position. In some examples, the force from the magnetic attraction causes the first pallet 810 to move to the open position at a speed greater than a speed of a pressure relief valve configured without the first magnet assembly 806. As a result, less travel time is needed to move the pressure relief valve 702 to an open position. In some examples, the first magnet 834 engages the second magnet 836 (e.g., directly engages such that the first distance 1110 is zero) when the pressure relief valve 702 is in a fully open position. In some examples, the first magnet 834 does not engage the second magnet 836 when the pressure relief valve 702 is in a fully open position (e.g., the first distance 1110 is greater than zero). As a pressure of a pressurized system decreases to a pressure at or below a closing pressure of the pressure relief valve 702, the first weight 1102 cause the first pallet 810 to move toward the first valve seat 804 toward the closed position. As a result, the first magnet 834 detaches from the second magnet 836 and the first pallet 810 moves toward the closed position. The closing pressure of the pressure relief valve 702 is less than the pressure set point of the first flow control assembly 802 (e.g., provided by the first weight 1102). For example, the system pressure drops to a pressure that provides a pressure differential across the first pallet 810 that enables the first weight 1102 to cause the first magnet 834 to detach from the second magnet 836 and move the first pallet 810 toward the closed position. In some examples, the closing pressure can be approximately 0.1-0.75 psig less than the pressure set point. In the closed position, the first weight 1102 causes the first gasket 812 of the first pallet 810 to engage (e.g., sealing engage) the first valve seat 804 to prevent or restrict fluid flow through the first valve seat 804 and/or the first flow path 108.

In operation, the second weight 1106 causes the second pallet 810′ to engage (e.g., sealingly engage) the second valve seat 804′ when a pressure of a fluid of the pressure system does not exceed a vacuum set point provided by the second weight 1106. In a closed position, the third magnet 834′ is spaced from and/or disengaged from the fourth magnet 836′ by a second distance 1112 (e.g., a maximum vertical distance in the orientation of FIG. 11) that reduces or prevents an attractive force between the third magnet 834′ and the fourth magnet 836′ (e.g., the third magnet 834′ does not attract the fourth magnet 836′). When a pressure of a fluid of the pressure system decreases to a pressure that does not exceed the vacuum set point, fluid at atmospheric pressure at the third port 116 causes the second pallet 810′ to move away from the second valve seat 804′ to allow fluid flow from the third port 116 to the pressure system via the second flow path 114. As a result, the second pallet 810′ and, thus, the third magnet 834′ move in a rectilinear direction toward the fourth magnet 836′. As the second distance 1112 between the third magnet 834′ and the fourth magnet 836′ decreases, a magnetic force between the third and fourth magnets 834′, 836′ increases. As a result, the third magnet 834′ attracts to the fourth magnet 836′ to cause the second pallet 810′ to move to an open position. In some examples, the force from the magnetic attraction causes the second pallet 810′ to move to the open position at a speed greater than a speed of a vacuum relief valve configured without the second magnet assembly 806′. As a result, less travel time is needed to move the vacuum relief valve 704 to an open position. In some examples, the third magnet 834′ engages the fourth magnet 836′ (e.g., directly engages such that the second distance 1112 is zero) when the vacuum relief valve 704 is in a fully open position. In some examples, the third magnet 834′ does not directly engage the fourth magnet 836′ when the vacuum relief valve 704 is in a fully open position (e.g., the second distance 1112 is greater than zero). As a pressure of a fluid of the pressure system increases to a pressure at or above a closing pressure (e.g., a pressure that exceeds the vacuum set point) of the second flow control assembly 802′, the second weight 1106 causes the second pallet 810′ to move toward the second valve seat 804′ toward the closed position. As a result, the third magnet 834′ detaches from the fourth magnet 836′ and the second pallet 810′ moves toward the closed position. The closing pressure of the vacuum relief valve 704 is greater than the pressure set point of the second flow control assembly 802′ (e.g., provided by the second weight 1106). For example, the system pressure increases to a pressure that provides a pressure differential across the second pallet 810′ that enables the second weight 1106 to cause the third magnet 834′ to detach from the fourth magnet 836′ and move the second pallet 810′ toward the closed position. In some examples, the closing pressure can be approximately 0.1-0.75 psig less than the pressure set point. In the closed position, the second weight 1106 causes the second gasket 812′ of the second pallet 810′ to engage (e.g., sealing engage) the second valve seat 804′ to prevent or restrict fluid flow through the second valve seat 804′ and/or the second flow path 114.

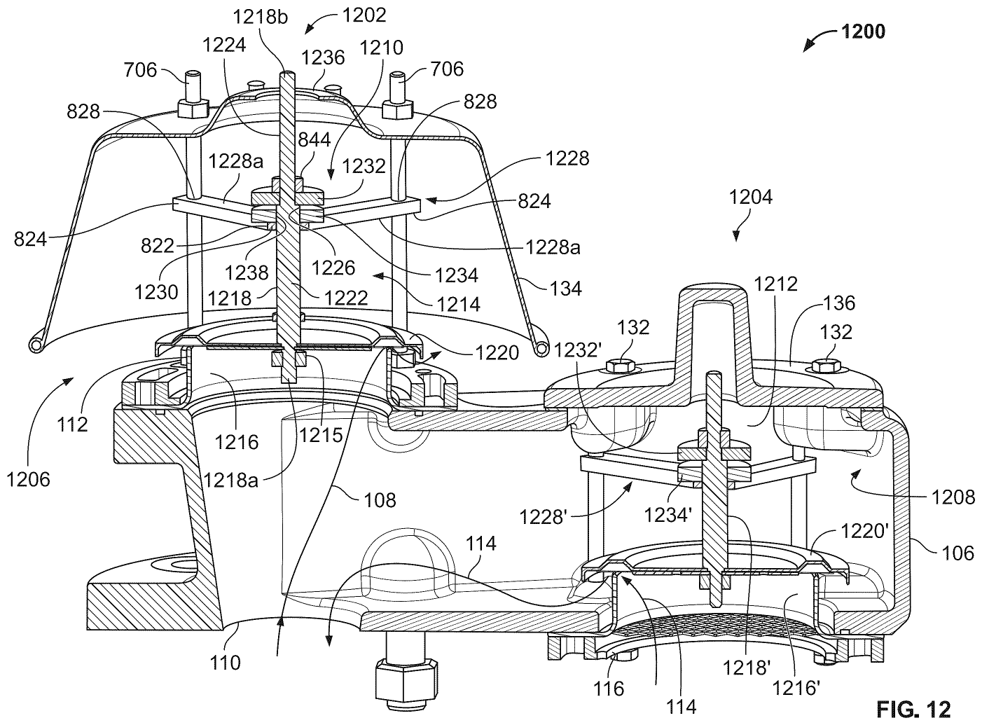

FIG. 12 is a perspective, cross-sectional view of another example relief valve 1200 disclosed herein. Many of the components of the example relief valve 1200 of FIG. 12 are substantially similar or identical to the components described above in connection with FIGS. 1A-11. As such, those components will not be described in detail again below. Instead, the interested reader is referred to the above corresponding descriptions for a complete written description of the structure and operation of such components. To facilitate this process, similar or identical reference numbers will be used for like structures as used in FIGS. 1A-11 above.

For example, the relief valve 1200 of FIG. 12 includes a valve body 106 having a pressure relief valve 1202 and a vacuum relief valve 1204. The valve body 106 defines a first flow path 108 between a first port 110 and a second port 112 and a second flow path 114 between a third port 116 and the first port 110. The pressure relief valve 1202 controls fluid flow through the first flow path 108 and the vacuum relief valve 1204 controls fluid through the second flow path 114. Additionally, the relief valve 1200 includes a weather hood 134 mounted to the valve body 106 to cover or protect the pressure relief valve 1202 and a vacuum cover 136 mounted to the valve body 106 to cover or protect the vacuum relief valve 1204. The weather hood 134 is coupled to the valve body 106 via a plurality of first mounting rods 706 (e.g., or the first fasteners 130 of FIG. 1A). The vacuum cover 136 is coupled to the valve body 106 via a plurality of second mounting rods 132.

Like the relief valve 100 of FIG. 1A, the example relief valve 1200 of the illustrated example employs a first trim assembly 1206 to provide a pressure set point of the pressure relief valve 1202 and a second trim assembly 1208 to provide a vacuum set point of the vacuum relief valve 1204. To provide the first pressure set point, the first trim assembly 1206 of the illustrated example includes a first magnet assembly 1210. To provide the vacuum set point, the second trim assembly 1208 includes a second magnet assembly 1212. In contrast to the example relief valve 100 of FIGS. 1A and 1B, the first magnet assembly 1210 of the illustrated example is located outside of the first flow path 108. Similarly, the second magnet assembly 1212 of the illustrated example is located outside of the second flow path 114.

The first trim assembly 1206 includes a first flow control assembly 1214 and a first valve seat 1216. The first valve seat 1216 includes a body 1216a and a flange 1216b that defines an orifice 1216c. The first flow control assembly 1214 of the illustrated example includes a first valve stem 1218 and a first pallet 1220. The first valve stem 1218 includes a first end 1218a coupled to the first pallet 1220 (e.g., via a first fastener 1215, clamp, or locking nut) and a second end 1218b opposite the first end 1218a. The first valve stem 1218 of the illustrated example includes a first body portion 1222 and a second body portion 1224. The first body portion 1222 has a first dimension (e.g., a first diameter) and the second body portion 1224 (e.g., a recessed portion) has a second dimension (e.g., a second diameter) different than (e.g., smaller than) the first dimension. In the illustrated example, a shoulder or step 1226 is positioned (e.g., at approximately at a midpoint) between the first end 1218a and the second end 1218b of the first valve stem 1218.

The first trim assembly 1206 also includes a first magnet holder 1228. The first magnet holder 1228 of the illustrated example is coupled to the valve body 106 via the first mounting rods 706. In some examples, the first magnet holder 1228 is positioned approximately adjacent to a midpoint length of the first mounting rods 706. For example, one or more fasteners can be used to fix a position of the first magnet holder 1228 relative to the first mounting rods 706 and/or the first pallet 1220. The first magnet holder 1228 includes a central opening 1230 to receive (e.g., slidably receive) the first valve stem 1218 (e.g., the first body portion 1222 of the first valve stem 1218). Thus, the second end 1218b of the first valve stem 1218 projects away from the first pallet 1220 and the first magnet holder 1228 toward the weather hood 134. In some examples, the first magnet holder 1228 guides (e.g., rectilinear movement of) the first valve stem 1218. The first magnet holder 1228 of the illustrated example is substantially similar to the first magnet holder 808 of FIGS. 8A and 8B. For example, the first magnet holder 808 of the illustrated example has an X-shaped profile. The first magnet holder 1228 of the illustrated example includes a plurality of arms 824 extending from a central area or hub 822. Respective ones of the arms 824 include openings 828 to receive respective ones of the first mounting rods 706.

The first magnet assembly 1210 of the illustrated example includes a first magnet 1232 and a second magnet 1234. In the illustrated example, the first magnet 1232 is coupled to the first valve stem 1218 (e.g., a second end 1218b or second body portion 1224). The first magnet 1232 is coupled to the first valve stem 1218 via a retainer 844 that fixes, fastens, or captures the first magnet 1232 between the retainer 844 and the step 1226. The first magnet holder 1228 of the illustrated example includes a first side 1228a oriented toward an upper surface 1236 of the weather hood 134 and/or a first stem guide 206 of FIG. 1A and a second side 1228b opposite the first side 1228a oriented toward the first pallet 1220. The second magnet 1234 is coupled to the first side 1228a of the first magnet holder 1228. For example, the second magnet 1334 is coupled (e.g., fastened or attached) to the first magnet holder 1228 via a weld, a retainer, a locking nut and/or any other fastener(s). The first magnet holder 1228 includes the central opening 1230 and the second magnet 1234 includes a central opening 1238 to slidably receive the first valve stem 1218 (e.g., the first body portion 1222 of the first valve stem 1218). In the illustrated example, the second magnet 1234 is positioned between the first magnet holder 1228 and the upper surface 1236 of the weather hood 134, and the first magnet 1232 is positioned between the second magnet 1234 and the upper surface 1236 of the weather hood 134. As noted above, the first magnet assembly 1210 is positioned outside of the first flow path 108 (e.g., downstream from the second port 112). As a result, the first valve seat 1216 of the illustrated example does not include any objects (e.g., the first magnet holder 414 and/or the ribs 418 of FIGS. 4A-4C, the first stem guide 912 of FIG. 9, etc.) in the orifice 1216c and/or between a first side and a second side of the first valve seat 1216.

In operation, when the pressure relief valve 1202 of the illustrated example is in a closed position, the first pallet 1220 engages the first valve seat 1216 to prevent fluid flow through the first flow path 108. In the closed position, the first magnet 1232 couples (e.g., directly engages) with the second magnet 1234 to provide a magnetic or attractive force that provides a pressure set point of the pressure relief valve 1202. In some examples, the first magnet 1232 can be spaced apart from the second magnet 1234 when the pressure relief valve 1202 is in a closed position (e.g., a fully closed position). In other words, in the closed position (e.g., a fully closed position) a distance (e.g., a vertical distance) between the first magnet 1232 and the second magnet 1234 is small or zero. The distance between the first magnet 1232 and the second magnet 1234 increases as the pressure relief valve 1202 moves to the open position (e.g., a fully open position). Thus, a magnetic force between the first magnet 1232 and the second magnet 1234 is greater when the first pallet 1220 is engaged with the first valve seat 1216 than when the first pallet 1220 is spaced away from the first valve seat 1216. In some examples, a non-magnetic spacer can be positioned between the first magnet 1232 and the second magnet 1234 when the pressure relief valve 1202 is in a closed position (e.g., a fully closed position) to adjust a magnetic force and, thus, a pressure set point of the pressure relief valve 1202. The first magnet 1232 and the second magnet 1234 can be similar to the first magnet 220 and the second magnet 222 of FIGS. 2A and 2B.

When a pressure of a pressure system in communication with the first port 110 of the pressure relief valve 1202 exceeds the pressure set point provided by the first magnet assembly 1210, the first pallet 1220 moves away from (e.g., disengages from) the first valve seat 1216 to allow fluid flow from the first port 110 to the second port 112 via the first flow path 108. Given that the first valve stem 1218 is rigidly coupled or fixed to the first pallet 1220, movement of the first pallet 1220 relative to the first valve seat 1216 causes movement of the first valve stem 1218 and the first magnet 1232 (e.g., in a vertical or rectilinear direction). As the first pallet 1220 moves in a direction away from the first valve seat 1216, the first magnet 1232 moves away (e.g., separates and/or detaches) from the second magnet 1234, thereby increasing a distance (e.g., a vertical distance) between the first magnet 1232 and the second magnet 1234 and reducing the attractive force between the first magnet 1232 and the second magnet 1234. For example, the first magnet 1232 moves toward the upper surface 1236 of the weather hood 134 via the first valve stem 1218 and the second magnet 1234 remains fixed relative to the first valve stem 1218 via the first magnet holder 1228. Thus, as the first pallet 1220 moves from the closed position to an open position (e.g., a fully open position), an opening force needed to move the first pallet 1220 reduces as the first pallet 1220 moves to a fully open position (e.g., because the attractive or magnetic force between the first magnet 1232 and the second magnet 1234 decreases). In some examples, the relief valve 1200 can include a stem guide (e.g., the first stem guide 206 of FIG. 1A) that attaches to the upper surface 1236 of the weather hood 134 to receive and/or guide the second end 1218b of the first valve stem 1218. When the pressure of the pressure system does not exceed the pressure set point, the first pallet 1220 moves toward the first valve seat 1216 and the first magnet 1232 moves toward the second magnet 1234 (e.g., thereby reducing the vertical distance between the first magnet 1232 and the second magnet 1234). As the first magnet 1232 moves toward the second magnet 1234 as the first pallet 1220 moves from an open position to a closed position, the attractive or magnetic force between the first magnet 1232 and the second magnet 1234 increases, thereby causing the first pallet 1220 to sealing engage the first valve seat 1216. In some examples, gravity can assist movement of the first pallet 1220 toward the first valve seat 1216 (e.g., the closed position). In some examples, the first trim assembly 1206 can include a weight (e.g., the first weight 1102 of FIG. 11). In some such examples, the weight and a force between the first magnet assembly 1210 provides the pressure set point of the pressure relief valve 1202.

In the illustrated example, a second trim assembly 1208 of the vacuum relief valve 1204 is substantially similar or identical to the first trim assembly 1206. For example, the second trim assembly 1208 includes a second flow control assembly 1214′, a second valve seat 1216′, a second magnet holder 1228′ and the second magnet assembly 1212. The second flow control assembly 1214′ includes a second valve stem 1218′ and a second pallet 1220′. The second magnet assembly 1212 includes a third magnet 1232′ and a fourth magnet 1234′. The second trim assembly 1208 of the illustrated example operates similar or identical to the first trim assembly 1206 to control fluid flow between the third port 116 and the first port 110 via the second flow path 114.

In some examples, the second magnet 1234 and/or the fourth magnet 1234′ can be omitted. In some examples, the first magnet holder 1228 and/or the second magnet holder 1228′ can be composed of a metal or other material that establishes a magnetic force or attraction with the first magnet 1232 and/or the third magnet 1232′. In some examples, the first magnet 1232 and/or the third magnet 1232′ can be omitted and the metallic structure (e.g., a washer, an iron washer, a steel washer) and/or other structure that establishes a magnetic force or attraction with the second magnet 1234 and/or the fourth magnet 1234′ can be coupled to the first valve stem 1218 and/or the second valve stem 1218′.

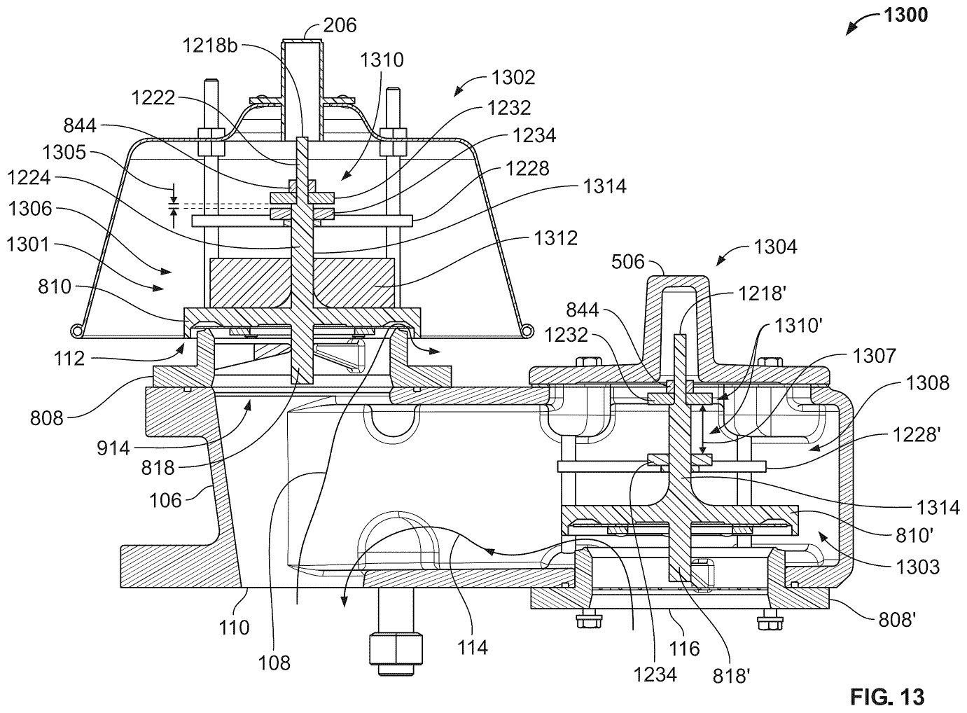

FIG. 13 is a front, cross-sectional view of another example relief valve 1300 disclosed herein. Many of the components of the example relief valve 1300 of FIG. 13 are substantially similar or identical to the components described above in connection with the relief valve 100, 700, and 1200 of FIGS. 1A-12. As such, those components will not be described in detail again below. Instead, the interested reader is referred to the above corresponding descriptions for a complete written description of the structure and operation of such components. To facilitate this process, similar or identical reference numbers will be used for like structures as used in FIGS. 1A-12 above.

For example, the relief valve 1300 of FIG. 13 includes a valve body 106 having a pressure relief valve 1302 and a vacuum relief valve 1304. The pressure relief valve 1302 controls fluid flow through a first flow path 108 and the vacuum relief valve 1304 controls fluid through the second flow path 114. The pressure relief valve 1302 includes a first trim assembly 1306 that provides a pressure set point for the pressure relief valve 1302 and a second trim assembly 1308 that provides a vacuum pressure set point for the vacuum relief valve 1304.

The first trim assembly 1306 of the illustrated example includes a first magnet assembly 1310 and a first weight 1312 to provide the pressure set point of the pressure relief valve 1302. Specifically, the first magnet assembly 1310 is substantially similar to the first magnet assembly 1210 of the first trim assembly 1206 of FIG. 12. For instance, the first magnet assembly 1310 includes a first magnet 1232 and a second magnet 1234. Additionally, the first trim assembly 1306 includes a first valve seat 804, the first pallet 810, the first guide stem 818, the first gasket 812 (FIG. 8B), and the first retainer 814 (FIG. 8B). However, the first trim assembly 1306 of the illustrated example includes a first valve stem 1314. The first valve stem 1314 of the illustrated example is substantially similar to the first valve stem 1218 of FIG. 12. For example the first valve stem 1314 includes a first body portion 1222 and a second body portion 1224. Thus, the first trim assembly 1306 is a hybrid between the first trim assembly 800 of FIGS. 8A and 8B and the first trim assembly 1206 of FIG. 12. For example, the first valve stem 1314, the first pallet 810, and the first guide stem 818 of the illustrated example are a uniform or unitary structure (e.g., a monolithic body). The first magnet 1232 is coupled to a second end 1218b of the first valve stem 1314 via a retainer 844 and the second magnet 1234 is coupled to the first magnet holder 1228. Similar to the first trim assembly 1206 of FIG. 12, the first magnet 1232 of the illustrated example is positioned between the second magnet 1234 and a first stem guide 206 of the relief valve 1300. Thus, the first magnet 1232 is positioned above the second magnet 1234 in the orientation of FIG. 13. Specifically, the first magnet assembly 1310 is positioned above the first weight 1312 and/or outside of the first flow path 108 (e.g., and/or an orifice 906 of the first valve seat 804).

In operation, the first trim assembly 1306 operates substantially similar or identical to the first trim assembly 1206 of FIG. 12. Specifically, in a closed position 1301, the first pallet 810 engages the first valve seat 804 and the first magnet 1232 is positioned adjacent the second magnet 1234. In some examples, in a fully closed position, the first magnet 1232 directly engages the second magnet 1234 (e.g., a vertical distance between the first magnet 1232 and the second magnet 1234 is zero). In some examples, in a fully closed position (e.g., the closed position 1301), the first magnet 1232 is spaced from the second magnet 1234 (e.g., a vertical distance between the first magnet 1232 and the second magnet 1234 is greater than zero). As the first pallet 810 moves away from the first valve seat 804 when the pressure relief valve 1302 moves to an open position (e.g., similar to an open position 1303 of the vacuum relief valve 1304), the magnetic force between the first magnet 1232 and the second magnet 1234 decreases as a distance 1305 (e.g., a vertical distance) between the first magnet 1232 and the second magnet 1234 increases. Thus, an opening force needed to move the first pallet 810 to a fully open position decreases as the first pallet 810 moves toward the first magnet holder 1228 to an open position (e.g., a fully open position).

The second trim assembly 1308 of the vacuum relief valve 1304 is substantially similar or identical to the first trim assembly 1306. The second trim assembly 1308 of the illustrated example includes a second magnet assembly 1310′ and a second weight 1312′ to provide a pressure set point of the vacuum relief valve 1304. Specifically, the second magnet assembly 1310′ is substantially similar to the third magnet assembly 1210′ of the second trim assembly 1208 of FIG. 12. For instance, the second magnet assembly 1310′ includes a third magnet 1232′ and a fourth magnet 1234′. Additionally, the second trim assembly 1304 includes a second valve stem 1314′, a second valve seat 804′, a second pallet 810′, a second guide stem 818′, a second gasket 812′ (FIG. 10B), a second retainer 814′ (FIG. 10B), and a second magnet holder 1228′. The third magnet 1232′ is coupled to a second end 1218b of the second valve stem 1314′ via a second retainer 844′ and the fourth magnet 1234′ is coupled to the second magnet holder 1228′. The third magnet 1232′ is positioned between the fourth magnet 1234′ and a second stem guide 502 provided by a vacuum cover 136. The second trim assembly 1308 operates substantially similar or identical to the first trim assembly 1306 to enable atmospheric air from the third port 116 to the first port 110 via the second flow path 114 when an under-pressurization condition exits in a pressure system coupled to the first port 110. In FIG. 13, the vacuum relief valve 1304 is shown in the open position 1303 (e.g., a fully open position). In the open position 1303, the third magnet 1232′ is spaced from the fourth magnet 1234′ by a distance 1307. In the closed position (e.g., similar to the closed position 1301 of the pressure relief valve 1302), the distance 1307 between the third magnet 1232′ and the fourth magnet 1234′ reduces and/or the third and fourth magnets 1232′, 1234′ engage. Although not shown, the vacuum relief valve 1304 can include a weight (e.g., the weight 1312).

The weights 1102, 1106 and/or 1312 are made of lead-free materials (e.g., negligible traces of lead). As a result first magnet assembly 1310 to assist with providing the pressure set point of the pressure relief valve 1302, the first weight 1312 can be made using less dense materials and/or materials not including lead. Thus, example relief valves 100, 700, 1200, 1300 disclosed herein provide environment-friendly solution to using weights composed of lead.

The foregoing example relief valves 100, 700, 1200, 1300 can be a pressure relief device and/or vacuum relief device. In some examples, the pressure relief valves 102, 702, 1202 and 1302 can be formed independently or as separate valve bodies from the vacuum relief valves 104, 704, 1204 and 1304. Although each relief valves 100, 700, 1200, 1300 disclosed above have certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Example methods, apparatus, systems, and articles of manufacture to fluid valves are disclosed herein. Further examples and combinations thereof include the following:

Example 1 includes a relief valve including a valve body defining a fluid flow path between a first port and a second port. A valve seat is interposed in the fluid flow path. A pallet is movable relative to the valve seat from a closed position and an open position in response to a pressure differential across the pallet exceeding a set point of the relief valve. A valve stem is coupled to the pallet. A magnet assembly is to provide a magnetic attraction force to at least partially assist in moving the pallet away from the valve seat when the pallet is moving from the closed position to the open position.

Example 2 includes the relief valve of example 1, where the magnet assembly is positioned outside of the fluid flow path.

Example 3 includes the relief valve of any one of examples 1-2, where the magnet assembly includes a first magnet coupled to the valve stem and a second magnet coupled to a magnet holder.

Example 4 includes the relief valve of any one of examples 1-3, where the valve stem includes a first end coupled to the pallet and a second end opposite the first end, the first magnet coupled to the second end of the valve stem.

Example 5 includes the relief valve of any one of examples 1-4, where the second end of the valve stem includes a recess defining a step, the first magnet is captured between a retainer and the step of the valve stem.

Example 6 includes the relief valve of any one of examples 1-5, where the magnet holder includes a boss and a plurality of legs extending from the boss.

Example 7 includes the relief valve of any one of examples 1-6, wherein the second magnet is coupled to the boss via a fastener.

Example 8 includes the relief valve of any one of examples 1-7, wherein each of the legs of the magnet holder includes a first end coupled to the boss and a second end opposite the first end extending from the boss, the second end including an aperture.

Example 9 includes the relief valve of any one of examples 1-8, further including a plurality of rods, respective ones of the rods to couple the magnet holder and the relief valve, wherein the magnet holder is suspended downstream from the vent port.

Example 10 includes the relief valve of any one of examples 1-9, wherein the rods suspend the magnet holder within the relief valve.

Example 11 includes the relief valve of any one of examples 1-10, wherein an attractive force between the first magnet and the second magnet is greater when the pallet is spaced away from the valve seat than when the pallet is in engagement with the valve seat.

Example 12 includes the relief valve of any one of examples 1-11, wherein the magnet holder is a plate.

Example 13 includes a relief valve including a valve body defining a fluid flow path between an inlet port and an outlet port, a valve seat interposed in the fluid flow path, a pallet movable relative to the valve seat, the pallet having a first side oriented toward the valve seat and a second side opposite the first side, a valve stem having a first end coupled to the second side of the pallet and a second end extending therefrom, a magnet holder suspended adjacent the second end of the valve stem, and a magnet assembly to provide a pressure set point of the relief valve, the magnet assembly including a first magnet and a second magnet, the first magnet coupled to the second end of the valve stem, the second magnet coupled to the magnet holder.

Example 14 includes the relief valve of example 13, wherein the magnet assembly is positioned outside of the flow path between the inlet port and the outlet port.

Example 15 includes the relief valve of any one of examples 13-14, wherein the magnet holder is a plate having a boss and a plurality of arms extending therefrom, the magnet holder being suspended relative to the relief valve via a plurality of fasteners.

Example 16 includes the relief valve of any one of examples 13-15, wherein a magnetic force between the first magnet and the second magnet is greater when the pallet is in engagement with the valve seat than when the pallet is spaced away from the valve seat.

Example 17 includes a relief valve includes a valve body defining a fluid flow path between a first port and a second port, and a trim assembly to control fluid flow through the fluid flow path, the trim assembly including a valve seat positioned in the second port, a pallet moveable relative to the valve seat, a valve stem having a first end coupled to the pallet and a second end protruding away from the pallet, a first magnet coupled to the second end of the valve stem, a magnet holder positioned adjacent the second end of the valve stem, and a second magnet coupled to the magnet holder, the first magnet and the second magnet positioned outside of the fluid flow path.

Example 18 includes the relief valve of example 17, wherein the first magnet and the second magnet provide a pressure set point of the relief valve.

Example 19 includes the relief valve of any one of examples 17-18, wherein the first magnet engages the second magnet when the relief valve is in a closed position.

Example 20 includes the relief valve of any one of examples 17-19, wherein the first magnet and the second magnet assist movement of the pallet from a closed position to an open position, wherein the first magnet is detached and spaced away from the second magnet when the relief valve is in the closed position.

Example 21 includes a relief valve including a valve body defining a fluid flow path between a first port and a second port, a valve seat interposed in the fluid flow path, a pallet movable relative to the valve seat from a closed position and an open position in response to a pressure differential across the pallet exceeding a set point of the relief valve, a valve stem coupled to the pallet, and a magnet assembly to provide a magnetic attraction force to at least partially assist in moving the pallet toward the valve seat when the pallet moves from the open position to the closed position.

Example 22 includes the relief valve of example 21, wherein the magnet assembly is positioned inside of the fluid flow path.

Example 23 includes the relief valve of any one of examples 21-22, wherein the magnet assembly includes a first magnet coupled to the valve stem and a second magnet coupled to a magnet holder.

Example 24 includes the relief valve of any one of examples 21-23, wherein the valve stem includes a first end coupled to the pallet and a second end opposite the first end, the first magnet coupled to the first end of the valve stem.

Example 25 includes the relief valve of any one of examples 21-24, wherein the valve seat includes a magnet holder to retain the second magnet.

Example 26 includes the relief valve of any one of examples 21-25, wherein the magnet holder includes a boss and a plurality of legs extending from the boss.

Example 27 includes the relief valve of any one of examples 21-26, wherein the second magnet is coupled to the boss via a fastener.

Example 28 includes the relief valve of any one of examples 21-27, wherein each of the legs of the magnet holder includes a first end coupled to the boss and a second end opposite the first end extending from the boss and coupled to an inner surface of the valve seat.

Example 29 includes the relief valve of any one of examples 21-28, wherein an attractive force between the first magnet and the second magnet is less when the pallet is spaced away from the valve seat than when the pallet is engaged with the valve seat.

Example 30 includes the relief valve of any one of examples 21-29, wherein the relief valve does not include a biasing element to bias the pallet toward the closed position.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A relief valve comprising:
a valve body defining a fluid flow path between a first port and a second port;
a valve seat interposed in the fluid flow path;
a pallet movable relative to the valve seat from a closed position and an open position in response to a pressure differential across the pallet exceeding a set point of the relief valve;
a valve stem coupled to the pallet; and
a magnet assembly to provide a magnetic attraction force to at least partially assist in moving the pallet away from the valve seat when the pallet is moving from the closed position to the open position.

2. The relief valve of claim 1, wherein the magnet assembly is positioned outside of the fluid flow path.

3. The relief valve of claim 1, wherein the magnet assembly includes a first magnet coupled to the valve stem and a second magnet coupled to a magnet holder.

4. The relief valve of claim 3, wherein the valve stem includes a first end coupled to the pallet and a second end opposite the first end, the first magnet coupled to the second end of the valve stem.

5. The relief valve of claim 4, wherein the second end of the valve stem includes a recess defining a step, the first magnet is captured between a retainer and the step of the valve stem.

6. The relief valve of claim 5, wherein the magnet holder includes a boss and a plurality of legs extending from the boss.

7. The relief valve of claim 6, wherein the second magnet is coupled to the boss via a fastener.

8. The relief valve of claim 7, wherein each of the legs of the magnet holder includes a first end coupled to the boss and a second end opposite the first end extending from the boss, the second end including an aperture.

9. The relief valve of claim 8, further including a plurality of rods, respective ones of the rods to couple the magnet holder and the relief valve, wherein the magnet holder is suspended downstream from the vent port.

10. The relief valve of claim 9, wherein the rods suspend the magnet holder within the relief valve.

11. The relief valve of claim 3, wherein an attractive force between the first magnet and the second magnet is greater when the pallet is spaced away from the valve seat than when the pallet is in engagement with the valve seat.

12. The relief valve of claim 3, wherein the magnet holder is a plate.

13. A relief valve comprising:
a valve body defining a fluid flow path between an inlet port and an outlet port;
a valve seat interposed in the fluid flow path;
a pallet movable relative to the valve seat, the pallet having a first side oriented toward the valve seat and a second side opposite the first side;
a valve stem having a first end coupled to the second side of the pallet and a second end extending therefrom;
a magnet holder suspended adjacent the second end of the valve stem; and
a magnet assembly to provide a pressure set point of the relief valve, the magnet assembly including a first magnet and a second magnet, the first magnet coupled to the second end of the valve stem, the second magnet coupled to the magnet holder.

14. The relief valve of claim 13, wherein the magnet assembly is positioned outside of the flow path between the inlet port and the outlet port.

15. The relief valve of claim 13, wherein the magnet holder is a plate having a boss and a plurality of arms extending therefrom, the magnet holder being suspended relative to the relief valve via a plurality of fasteners.

16. The relief valve of claim 13, wherein a magnetic force between the first magnet and the second magnet is greater when the pallet is in engagement with the valve seat than when the pallet is spaced away from the valve seat.

17. A relief valve comprising:
a valve body defining a fluid flow path between a first port and a second port; and
a trim assembly to control fluid flow through the fluid flow path, the trim assembly including:
a valve seat positioned in the second port;
a pallet moveable relative to the valve seat,
a valve stem having a first end coupled to the pallet and a second end protruding away from the pallet;
a first magnet coupled to the second end of the valve stem;
a magnet holder positioned adjacent the second end of the valve stem; and
a second magnet coupled to the magnet holder, the first magnet and the second magnet positioned outside of the fluid flow path.

18. The relief valve of claim 17, wherein the first magnet and the second magnet provide a pressure set point of the relief valve.

19. The relief valve of claim 17, wherein the first magnet engages the second magnet when the relief valve is in a closed position.

20. The relief valve of claim 17, wherein the first magnet and the second magnet assist movement of the pallet from a closed position to an open position, wherein the first magnet is detached and spaced away from the second magnet when the relief valve is in the closed position.

21. A relief valve comprising:
a valve body defining a fluid flow path between a first port and a second port;
a valve seat interposed in the fluid flow path;
a pallet movable relative to the valve seat from a closed position and an open position in response to a pressure differential across the pallet exceeding a set point of the relief valve;
a valve stem coupled to the pallet; and
a magnet assembly to provide a magnetic attraction force to at least partially assist in moving the pallet toward the valve seat when the pallet moves from the open position to the closed position.

22. The relief valve of claim 21, wherein the magnet assembly is positioned inside of the fluid flow path.

23. The relief valve of claim 21, wherein the magnet assembly includes a first magnet coupled to the valve stem and a second magnet coupled to a magnet holder.

24. The relief valve of claim 23, wherein the valve stem includes a first end coupled to the pallet and a second end opposite the first end, the first magnet coupled to the first end of the valve stem.

25. The relief valve of claim 24, wherein the valve seat includes a magnet holder to retain the second magnet.

26. The relief valve of claim 25, wherein the magnet holder includes a boss and a plurality of legs extending from the boss.

27. The relief valve of claim 26, wherein the second magnet is coupled to the boss via a fastener.

28. The relief valve of claim 27, wherein each of the legs of the magnet holder includes a first end coupled to the boss and a second end opposite the first end extending from the boss and coupled to an inner surface of the valve seat.

29. The relief valve of claim 23, wherein an attractive force between the first magnet and the second magnet is less when the pallet is spaced away from the valve seat than when the pallet is engaged with the valve seat.

30. The relief valve of claim 23, wherein the relief valve does not include a biasing element to bias the pallet toward the closed position.
